(19) United States
(12) Patent Application Publication
(10) Pub. No.: US 2022/0066264 A1
(43) Pub. Date: Mar. 3, 2022

(54) OPTICAL ELEMENT, WAVELENGTH SELECTIVE FILTER, AND SENSOR

(71) Applicant: FUJIFILM Corporation, Tokyo (JP)

(72) Inventors: Yukito SAITOH, Minamiashigara-shi (JP); Hiroshi SATO, Minamiashigara-shi (JP); Katsumi SASATA, Minamiashigara-shi (JP); Takao TAGUCHI, Minamiashigara-shi (JP); Akiko WATANO, Minamiashigara-shi (JP)

(73) Assignee: FUJIFILM Corporation, Tokyo (JP)

(21) Appl. No.: 17/522,457

(22) Filed: Nov. 9, 2021

Related U.S. Application Data
(63) Continuation of application No. PCT/JP2020/018562, filed on May 7, 2020.

(30) Foreign Application Priority Data
May 10, 2019 (JP) 2019-089780
Dec. 27, 2019 (JP) 2019-238541

(51) Int. Cl. G02F 1/1335; G02F 1/1337; G02F 1/139; G02F 1/1516

(52) U.S. Cl. CPC G02F 1/133543; G02F 1/15165; G02F 1/1396; G02F 1/1337

(57) ABSTRACT

Provided are an optical element with which reflected light in a narrower wavelength range can be obtained and a wavelength selective filter and a sensor including the same optical element. The optical element includes a cholesteric liquid crystal layer obtained by cholesteric alignment of a liquid crystal compound, in which the cholesteric liquid crystal layer has a liquid crystal alignment pattern in which a direction of an optical axis derived from a liquid crystal compound changes while continuously rotating in at least one in-plane direction, and the cholesteric liquid crystal layer has a region where a refractive index nx in an in-plane slow axis direction and a refractive index ny in an in-plane fast axis direction satisfy nx>ny.

### CROSS-REFERENCE TO RELATED APPLICATIONS

This application is a Continuation of PCT International Application No. PCT/JP2020/018562 filed on May 7, 2020, which claims priority under 35 U.S.C. § 119(a) to Japanese Patent Application No. 2019-089780 filed on May 10, 2019 and Japanese Patent Application No. 2019-238541 filed on Dec. 27, 2019. Each of the above applications is hereby expressly incorporated by reference, in its entirety, into the present application.

### BACKGROUND OF THE INVENTION

### 1. Field of the Invention

The present invention relates to an optical element that diffracts incident light and a wavelength selective filter and a sensor that include the optical element.

### 2. Description of the Related Art

As the optical element, the use of a cholesteric liquid crystal layer obtained by cholesteric alignment of a liquid crystal compound is disclosed.

For example, WO2016/194961A discloses a reflective structure comprising: a plurality of helical structures each extending in a predetermined direction; a first incidence surface that intersects the predetermined direction and into which light is incident; and a reflecting surface that intersects the predetermined direction and reflects the light incident from the first incidence surface, in which the first incidence surface includes one of end portions in each of the plurality of helical structures, each of the plurality of helical structures includes a plurality of structural units that lies in the predetermined direction, each of the plurality of structural units includes a plurality of elements that are helically turned and laminated, each of the plurality of structural units includes a first end portion and a second end portion, the second end portion of one structural unit among structural units adjacent to each other in the predetermined direction forms the first end portion of the other structural unit, alignment directions of the elements positioned in the plurality of first end portions included in the plurality of helical structures are aligned, the reflecting surface includes at least one first end portion included in each of the plurality of helical structures, and the reflecting surface is not parallel to the first incidence surface. JP2005-513241A describes a helical structure obtained by cholesteric alignment of a liquid crystal compound. In addition, a reflective structure described in JP2005-513241A reflects and diffracts incident light.

In addition, JP2005-513241A describes a biaxial film having a cholesteric structure and a deformed helix with an elliptical refractive index ellipsoid, the biaxial film reflecting light having a wavelength of shorter than 380 nm.

### SUMMARY OF THE INVENTION

The cholesteric liquid crystal layer having the cholesteric structure has wavelength-selective reflectivity. Therefore, in a case where broad light is incident into the cholesteric liquid crystal layer, the cholesteric liquid crystal layer reflects only light in the selective reflection wavelength range and allows transmission of light in the other wavelength range. Accordingly, this cholesteric liquid crystal layer can be considered to be used as a filter that selects only light having a specific wavelength by using properties of the cholesteric liquid crystal layer. However, in a cholesteric liquid crystal layer in the related art, a wavelength range where light is reflected has a certain width, and it is difficult to obtain reflected light in a narrower wavelength range.

An object of the present invention is to provide an optical element with which reflected light in a narrower wavelength range can be obtained and a wavelength selective filter and a sensor including the optical element.

In order to achieve the object, the present invention has the following configurations.
[1] An optical element comprising:
a cholesteric liquid crystal layer obtained by cholesteric alignment of a liquid crystal compound,
in which the cholesteric liquid crystal layer has a liquid crystal alignment pattern in which a direction of an optical axis derived from a liquid crystal compound changes while continuously rotating in at least one in-plane direction, and
the cholesteric liquid crystal layer has a region where a refractive index nx in an in-plane slow axis direction and a refractive index ny in an in-plane fast axis direction satisfy nx>ny.
[2] The optical element according to [1],
in which in a case where a thickness of the cholesteric liquid crystal layer is represented by d, (nx−ny)×d is 47 nm or more.
[3] The optical element according to [1] or [2],
in which the liquid crystal alignment pattern of the cholesteric liquid crystal layer is a concentric circular pattern having a concentric circular shape where the one in-plane direction in which the direction of the optical axis derived from the liquid crystal compound changes while continuously rotating moves from an inside toward an outside.
[4] The optical element according to any one of [1] to [3],
in which in a case where a length over which the direction of the optical axis derived from the liquid crystal compound in the liquid crystal alignment pattern rotates by 180° in a plane is set as a single period, the cholesteric liquid crystal layer has regions in which lengths of the single periods in the liquid crystal alignment pattern in a plane.
[5] The optical element according to any one of [1] to [4], comprising:
two or more of the cholesteric liquid crystal layers,
in which helical pitches of cholesteric structures of the cholesteric liquid crystal layers are different from each other.
[6] The optical element according to any one of [1] to [5], comprising:
two or more of the cholesteric liquid crystal layers,
in which in a case where a length over which the direction of the optical axis derived from the liquid crystal compound in the liquid crystal alignment pattern rotates by 180° in a plane is set as a single period, the lengths of the single periods in the liquid crystal alignment patterns of the cholesteric liquid crystal layers are different from each other.
[7] The optical element according to any one of [1] to [6],
in which the cholesteric liquid crystal layer is formed of a liquid crystal elastomer.
[8] A wavelength selective filter comprising:
the optical element according to any one of [1] to [7].
[9] A sensor comprising:
the optical element according to any one of [1] to [7]; and
a light-receiving element that receives light reflected from the optical element.

According to the present invention, it is possible to provide an optical element with which reflected light in a narrower wavelength range can be obtained and a wavelength selective filter and a sensor including the same optical element.

### BRIEF DESCRIPTION OF THE DRAWINGS

FIG. 1 is a cross-sectional view conceptually showing an example of an optical element according to the present invention.

FIG. 2 is a diagram showing a part of a liquid crystal compound of a cholesteric liquid crystal layer in the optical element shown in FIG. 1 in case of being seen from a helical axis direction.

FIG. 3 is a diagram conceptually showing the cholesteric liquid crystal layer in the optical element shown in FIG. 1.

FIG. 4 is a front view showing the cholesteric liquid crystal layer shown in FIG. 3.

FIG. 5 is a conceptual diagram showing an example of an exposure device that exposes an alignment film of the cholesteric liquid crystal layer shown in FIG. 2.

FIG. 6 is a conceptual diagram showing an action of the cholesteric liquid crystal layer shown in FIG. 2.

FIG. 7 is a diagram showing a part of a plurality of liquid crystal compounds that are twisted and aligned along a helical axis in case of being seen from a helical axis direction.

FIG. 8 is a diagram conceptually showing an existence probability of the liquid crystal compound seen from the helical axis direction in the optical element according to the present invention.

FIG. 9 is a diagram conceptually showing an example of a cholesteric liquid crystal layer in the related art.

FIG. 10 is a diagram showing a part of a liquid crystal compound of the cholesteric liquid crystal layer in the related art shown in FIG. 9 in case of being seen from a helical axis direction.

FIG. 11 is a diagram conceptually showing an existence probability of the liquid crystal compound seen from the helical axis direction in the cholesteric liquid crystal layer in the related art.

FIG. 12 is a diagram conceptually showing another example of the arrangement of the liquid crystal compound in the cholesteric liquid crystal layer.

FIG. 13 is a diagram conceptually showing another example of the cholesteric liquid crystal layer in the optical element according to the present invention.

FIG. 14 is a front view conceptually showing another example of the cholesteric liquid crystal layer in the optical element according to the present invention.

FIG. 15 is a diagram showing an action of the optical element shown in FIG. 14.

FIG. 16 is a diagram showing the action of the optical element shown in FIG. 14.

FIG. 17 is a diagram conceptually showing an example of an exposure device that exposes an alignment film on which the cholesteric liquid crystal layer shown in FIG. 14 is to be formed.

FIG. 18 is a graph showing a relationship between a wavelength and a diffraction efficiency in primary reflected light according to Example 1.

FIG. 19 is a graph showing a relationship between a wavelength and a diffraction efficiency in secondary reflected light according to Example 1.

FIG. 20 is a graph showing a relationship between a wavelength and a diffraction efficiency in primary reflected light according to Comparative Example 1.

FIG. 21 is a graph showing a relationship between a wavelength and a diffraction efficiency in secondary reflected light according to Comparative Example 2.

FIG. 22 is a diagram conceptually showing an example of a wavelength selective element including the sensor according to the present invention.

### DESCRIPTION OF THE PREFERRED EMBODIMENTS

Hereinafter, an optical element, a wavelength selective filter, and a sensor according to an embodiment of the present invention will be described in detail based on a preferable embodiment shown in the accompanying drawings.

In the present specification, numerical ranges represented by “to” include numerical values before and after “to” as lower limit values and upper limit values.

In the present specification, “(meth)acrylate” represents “either or both of acrylate and methacrylate”.

In the present specification, visible light refers to light which can be observed by human eyes among electromagnetic waves and refers to light in a wavelength range of 380 to 780 nm. Invisible light refers to light in a wavelength range of shorter than 380 nm or longer than 780 nm.

In addition, although not limited thereto, in visible light, light in a wavelength range of 420 to 490 nm refers to blue light, light in a wavelength range of 495 to 570 nm refers to green light, and light in a wavelength range of 620 to 750 nm refers to red light.

[Optical Element]

The optical element according to the embodiment of the present invention comprises:

a cholesteric liquid crystal layer obtained by cholesteric alignment of a liquid crystal compound,

in which the cholesteric liquid crystal layer has a liquid crystal alignment pattern in which a direction of an optical axis derived from a liquid crystal compound changes while continuously rotating in at least one in-plane direction, and

the cholesteric liquid crystal layer has a region where a refractive index nx in an in-plane slow axis direction and a refractive index ny in an in-plane fast axis direction satisfy nx>ny.

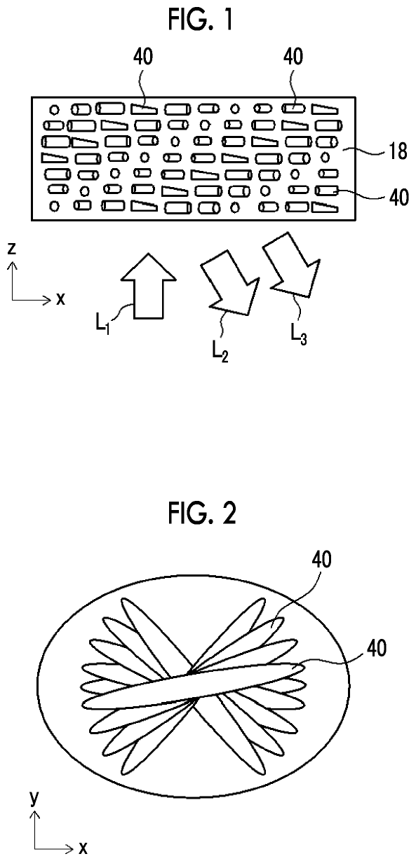

FIG. 1 is a diagram conceptually showing an example of the optical element according to the embodiment of the present invention.

An optical element 10 shown in FIG. 1 includes a cholesteric liquid crystal layer 18 obtained by cholesteric alignment of a liquid crystal compound 40. In the cholesteric liquid crystal layer 18, a molecular axis derived from the liquid crystal compound 40 is twisted and aligned along a helical axis. In the example shown in FIG. 1, the liquid crystal compound 40 is a rod-shaped liquid crystal compound, and a direction of the molecular axis derived from the liquid crystal compound matches a longitudinal direction of the liquid crystal compound 40. The helical axis is parallel to a thickness direction (in FIG. 1, the up-down direction) of the cholesteric liquid crystal layer 18.

In FIG. 1, the number of helices in the helical structure (cholesteric structure) in the thickness direction of the cholesteric liquid crystal layer 18 is half of a pitch. Actually, a helical structure corresponding to at least several pitches is provided.

In the following description, the thickness direction (the up-down direction in FIG. 1) of the optical element 10 (cholesteric liquid crystal layer 18) is set as a z direction, and plane directions perpendicular to the thickness direction are set as a x direction (the left-right direction in FIG. 1) and a y direction (direction perpendicular to the plane in FIG. 1).

That is, FIG. 1 is a diagram showing a cross-section parallel to the z direction and the x direction.

The cholesteric liquid crystal layer 18 has a liquid crystal alignment pattern in which a direction of an optical axis derived from a liquid crystal compound changes while continuously rotating in at least one in-plane direction.

By having the above-described liquid crystal alignment pattern, the cholesteric liquid crystal layer 18 can diffract light in a selective reflection wavelength to be reflected. At this time, in a case where a length over which the direction of the optical axis derived from the liquid crystal compound in the liquid crystal alignment pattern rotates by 180° in a plane is set as a single period (hereinafter also referred to as the single period of the liquid crystal alignment pattern), the diffraction angle depends on the length of the single period and the pitch of the helical structure. Therefore, the diffraction angle can be adjusted by adjusting the single period of the liquid crystal alignment pattern.

Further, the cholesteric liquid crystal layer 18 has a configuration in which, in a case where the arrangement of the liquid crystal compound 40 is seen from the helical axis direction, an angle between the molecular axes of the liquid crystal compounds 40 adjacent to each other gradually changes as shown in FIG. 2. In other words, in a case where the arrangement of the liquid crystal compound 40 is seen from the helical axis direction, the existence probability of the liquid crystal compound 40 varies. As a result, the cholesteric liquid crystal layer 18 has a configuration where a refractive index nx in the in-plane slow axis direction and a refractive index ny in the in-plane fast axis direction satisfy nx>ny.

In the following description, the cholesteric liquid crystal layer 18 having a configuration in which, in a case where the arrangement of the liquid crystal compound 40 is seen from the helical axis direction, an angle between the molecular axes of the liquid crystal compounds 40 adjacent to each other gradually changes as shown in FIG. 2 will also be referred to as the cholesteric liquid crystal layer 18 having a refractive index ellipsoid.

In the optical element according to the embodiment of the present invention, the cholesteric liquid crystal layer 18 has the liquid crystal alignment pattern, and the refractive index nx in the in-plane slow axis direction and the refractive index ny in the in-plane fast axis direction satisfy nx>ny. As a result, as reflected light to be reflected from the cholesteric liquid crystal layer 18, primary light and secondary light to be diffracted are obtained. At this time, the secondary light is obtained as light in a very narrower wavelength range than that of the primary light. The selective central reflection wavelength of the secondary light is half of the selective central reflection wavelength of the primary light. An action of the cholesteric liquid crystal layer 18 (optical element 10) will be described below in detail.

Hereinafter, the details of the cholesteric liquid crystal layer 18 will be described using the drawings.

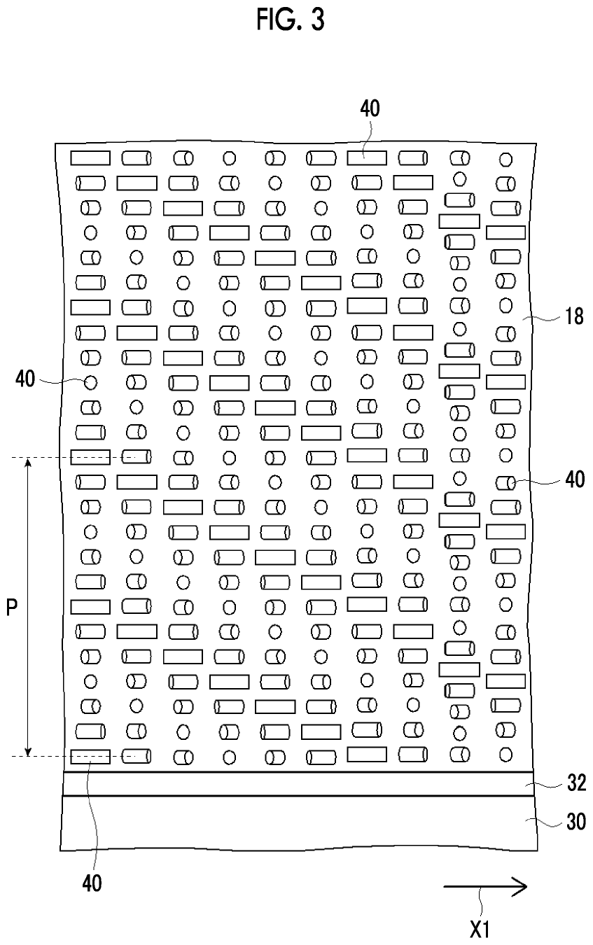

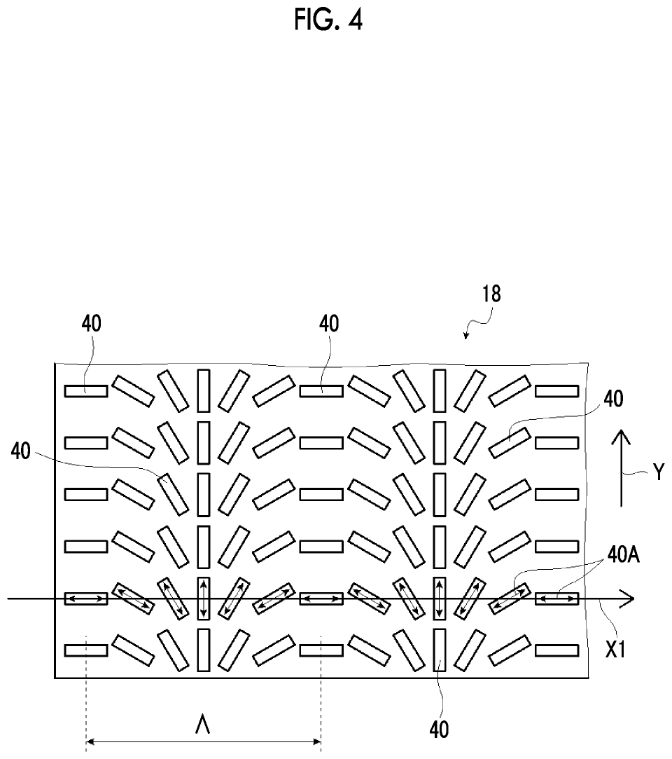

The cholesteric liquid crystal layer shown in FIGS. 3 and 4 is obtained by immobilizing a cholesteric liquid crystalline phase obtained by a cholesteric alignment of a liquid crystal compound, and has a liquid crystal alignment pattern in which a direction of an optical axis derived from a liquid crystal compound changes while continuously rotating in at least one in-plane direction.

In the example shown in FIG. 3, the cholesteric liquid crystal layer 18 is laminated on an alignment film 32 laminated on the support 30.

In a case where the cholesteric liquid crystal layer 18 is used as an optical element, the cholesteric liquid crystal layer 18 may be laminated in a state where it is laminated on the support 30 and the alignment film 32 as in the example shown in FIG. 3. Alternatively, for example, the cholesteric liquid crystal layer 18 may be laminated in a state where the support 30 is peeled off and only the alignment film 32 and the cholesteric liquid crystal layer 18 are laminated. Alternatively, for example, the cholesteric liquid crystal layer 18 may be laminated in a state where the support 30 and the alignment film 32 are peeled off and only the cholesteric liquid crystal layer 18 is present.

<Support>

The support 30 supports the alignment film 32 and the cholesteric liquid crystal layer 18.

As the support 30, various sheet-shaped materials (films or plate-shaped materials) can be used as long as they can support the alignment film 32 and the cholesteric liquid crystal layer 18.

A transmittance of the support 30 with respect to corresponding light is preferably 50% or higher, more preferably 70% or higher, and still more preferably 85% or higher.

The thickness of the support 30 is not particularly limited and may be appropriately set depending on the use of the optical element, a material for forming the support 30, and the like in a range where the alignment film 32 and the cholesteric liquid crystal layer 18 can be supported.

The thickness of the support 30 is preferably 1 to 1000 μm, more preferably 3 to 250 μm, and still more preferably 5 to 150 μm.

The support 30 may have a monolayer structure or a multi-layer structure.

In a case where the support 30 has a monolayer structure, examples thereof include supports formed of glass, triacetyl cellulose (TAC), polyethylene terephthalate (PET), polycarbonates, polyvinyl chloride, acryl, polyolefin, and the like. In a case where the support 30 has a multi-layer structure, examples thereof include a support including: one of the above-described supports having a monolayer structure that is provided as a substrate; and another layer that is provided on a surface of the substrate.

<Alignment Film>

In the optical element, the alignment film 32 is formed on a surface of the support 30.

The alignment film 32 is an alignment film for aligning the liquid crystal compound 40 to a predetermined liquid crystal alignment pattern during the formation of the cholesteric liquid crystal layer 18.

Although described below, in the present invention, the cholesteric liquid crystal layer 18 has a liquid crystal alignment pattern in which a direction of an optical axis 40A (refer to FIG. 4) derived from the liquid crystal compound 40 changes while continuously rotating in one in-plane direction. Accordingly, the alignment film 32 is formed such that the cholesteric liquid crystal layer 18 can form the liquid crystal alignment pattern.

In the following description, “the direction of the optical axis 40A rotates” will also be simply referred to as “the optical axis 40A rotates”.

As the alignment film 32, various well-known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as w-tricosanoic acid, dioctadecylmethylammonium chloride, or methyl stearate.

The alignment film 32 formed by a rubbing treatment can be formed by rubbing a surface of a polymer layer with paper or fabric in a given direction multiple times.

As the material used for the alignment film 32, for example, a material for forming polyimide, polyvinyl alcohol, a polymer having a polymerizable group described in JP1997-152509A (JP-H9-152509A), or an alignment film 32 such as JP2005-97377A, JP2005-99228A, and JP2005-128503A is preferable.

The alignment film 32 can be suitably used as a so-called photo-alignment film obtained by irradiating a photo-alignable material with polarized light or non-polarized light. That is, a photo-alignment film that is formed by applying a photo-alignable material to the support 30 is suitably used as the alignment film 32.

The irradiation of polarized light can be performed in a direction perpendicular or oblique to the photo-alignment film, and the irradiation of non-polarized light can be performed in a direction oblique to the photo-alignment film.

Preferable examples of the photo-alignable material used in the alignment film that can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A WO2010/150748A, JP2013-177561A, and JP2014-12823A.

Among these, an azo compound, a photocrosslinking polyimide, a photocrosslinking polyamide, a photocrosslinking polyester, a cinnamate compound, or a chalcone compound is suitably used.

The thickness of the alignment film 32 is not particularly limited. The thickness with which a required alignment function can be obtained may be appropriately set depending on the material for forming the alignment film 32.

The thickness of the alignment film 32 is preferably 0.01 to 5 μm and more preferably 0.05 to 2 μm.

A method of forming the alignment film 32 is not limited. Any one of various well-known methods corresponding to a material for forming the alignment film 32 can be used. For example, a method including: applying the alignment film 32 to a surface of the support 30; drying the applied alignment film 32; and exposing the alignment film 32 to laser light to form an alignment pattern can be used.

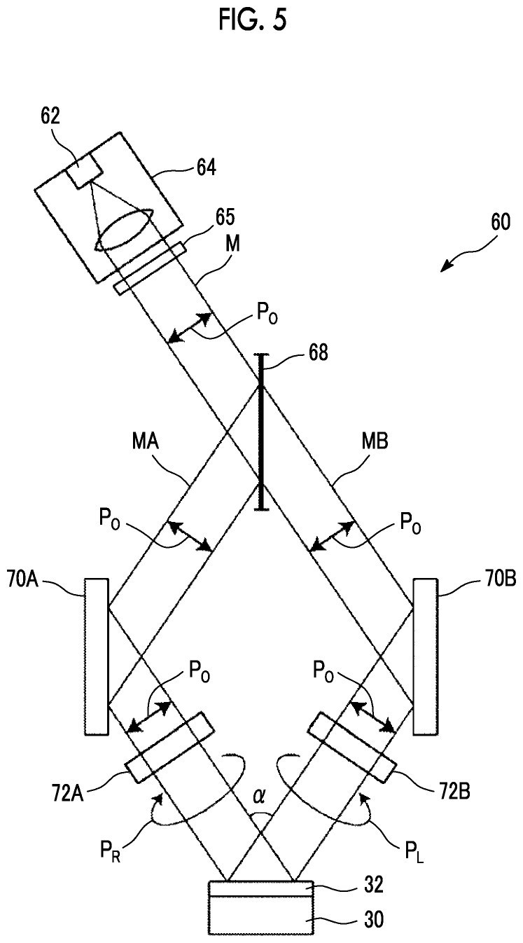

FIG. 5 conceptually shows an example of an exposure device that exposes the alignment film 32 to form an alignment pattern.

An exposure device 60 shown in FIG. 5 includes: a light source 64 including a laser 62; an λ/2 plate 65 that changes a polarization direction of laser light M emitted from the laser 62; a polarization beam splitter 68 that splits the laser light M emitted from the laser 62 into two beams MA and MB; mirrors 70A and 70B that are disposed on optical paths of the splitted two beams MA and MB; and λ/4 plates 72A and 72B.

The light source 64 emits linearly polarized light P₀. The λ/4 plate 72A converts the linearly polarized light P₀ (beam MA) into right circularly polarized light P_{R}, and the λ/4 plate 72B converts the linearly polarized light P₀ (beam MB) into left circularly polarized light P_{L}.

The support 30 including the alignment film 32 on which the alignment pattern is not yet formed is disposed at an exposed portion, the two beams MA and MB intersect and interfere each other on the alignment film 32, and the alignment film 32 is irradiated with and exposed to the interference light.

Due to the interference in this case, the polarization state of light with which the alignment film 32 is irradiated periodically changes according to interference fringes. As a result, an alignment film (hereinafter, also referred to as “patterned alignment film”) having an alignment pattern in which the alignment state changes periodically is obtained.

In the exposure device 60, by changing an intersecting angle α between the two beams MA and MB, the period of the alignment pattern can be adjusted. That is, by adjusting the intersecting angle α in the exposure device 60, in the alignment pattern in which the optical axis 40A derived from the liquid crystal compound 40 continuously rotates in the one in-plane direction, the length of the single period over which the optical axis 40A rotates by 180° in the one in-plane direction in which the optical axis 40A rotates can be adjusted.

By forming the cholesteric liquid crystal layer on the alignment film 32 having the alignment pattern in which the alignment state periodically changes, as described below, the cholesteric liquid crystal layer 18 having the liquid crystal alignment pattern in which the optical axis 40A derived from the liquid crystal compound 40 continuously rotates in the one in-plane direction can be formed.

In addition, by rotating the optical axes of the λ/4 plates 72A and 72B by 90°, respectively, the rotation direction of the optical axis 40A can be reversed.

As described above, the patterned alignment film has an alignment pattern in which the liquid crystal compound is aligned such that the direction of the optical axis of the liquid crystal compound in the cholesteric liquid crystal layer formed on the patterned alignment film changes while continuously rotating in at least one in-plane direction. In a case where an axis in the direction in which the liquid crystal compound is aligned is an alignment axis, it can be said that the patterned alignment film has an alignment pattern in which the direction of the alignment axis changes while continuously rotating in at least one in-plane direction. The alignment axis of the patterned alignment film can be detected by measuring absorption anisotropy. For example, in a case where the amount of light transmitted through the patterned alignment film is measured by irradiating the patterned alignment film with linearly polarized light while rotating the patterned alignment film, it is observed that a direction in which the light amount is the maximum or the minimum gradually changes in the one in-plane direction.

In the present invention, the alignment film 32 is provided as a preferable aspect and is not an essential component.

For example, the following configuration can also be adopted, in which, by forming the alignment pattern on the support 30 using a method of rubbing the support 30, a method of processing the support 30 with laser light or the like, or the like, the cholesteric liquid crystal layer has the liquid crystal alignment pattern in which the direction of the optical axis 40A derived from the liquid crystal compound 40 changes while continuously rotating in at least one in-plane direction. That is, in the present invention, the support 30 may be made to function as the alignment film.

<Cholesteric Liquid Crystal Layer>

The cholesteric liquid crystal layer 18 is formed on a surface of the alignment film 32.

As described above, the cholesteric liquid crystal layer 18 is a cholesteric liquid crystal layer that is obtained by immobilizing a cholesteric liquid crystalline phase and has a liquid crystal alignment pattern in which a direction of an optical axis derived from a liquid crystal compound changes while continuously rotating in at least one in-plane direction. In addition, the cholesteric liquid crystal layer 18 has a configuration where a refractive index nx in the in-plane slow axis direction and a refractive index ny in the in-plane fast axis direction satisfy nx>ny.

As conceptually shown in FIG. 3, the cholesteric liquid crystal layer 18 has a helical structure in which the liquid crystal compound 40 is helically turned and laminated as in a cholesteric liquid crystal layer obtained by immobilizing a typical cholesteric liquid crystalline phase. In the helical structure, a configuration in which the liquid crystal compound 40 is helically rotated once (rotated by 360°) and laminated is set as one helical pitch, and plural pitches of the helically turned liquid crystal compound 40 are laminated.

As is well-known, the cholesteric liquid crystal layer obtained by immobilizing a cholesteric liquid crystalline phase has wavelength-selective reflectivity.

Although described below in detail, the selective reflection wavelength range of the cholesteric liquid crystal layer depends on the length (pitch P shown in FIG. 3) of one helical pitch described above in the thickness direction.

<<Cholesteric Liquid Crystalline Phase>>

It is known that the cholesteric liquid crystalline phase exhibits selective reflectivity at a specific wavelength.

A center wavelength of selective reflection (selective reflection center wavelength) λ of a general cholesteric liquid crystalline phase depends on a helical pitch P in the cholesteric liquid crystalline phase and complies with a relationship of λ=n×P with an average refractive index n of the cholesteric liquid crystalline phase. Therefore, the selective reflection center wavelength can be adjusted by adjusting the helical pitch. In the present invention, light having a wavelength to be reflected according to the relationship of λ=n×P is primary light.

The selective reflection center wavelength of the cholesteric liquid crystalline phase increases as the pitch P increases.

As described above, the helical pitch P refers to one pitch (helical period) of the helical structure of the cholesteric liquid crystalline phase, in other words, one helical turn. That is, the helical pitch refers to the length in a helical axis direction in which a director (in the case of a rod-shaped liquid crystal, a major axis direction) of the liquid crystal compound constituting the cholesteric liquid crystalline phase rotates by 360°.

The helical pitch of the cholesteric liquid crystalline phase depends on the kind of the chiral agent used together with the liquid crystal compound and the concentration of the chiral agent added during the formation of the cholesteric liquid crystal layer. Therefore, a desired helical pitch can be obtained by adjusting these conditions.

The details of the adjustment of the pitch can be found in “Fuji Film Research & Development” No. 50 (2005), pp. 60 to 63. As a method of measuring a helical sense and a helical pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

The cholesteric liquid crystalline phase exhibits selective reflectivity with respect to left or circularly polarized light at a specific wavelength. Whether or not the reflected light is right circularly polarized light or left circularly polarized light is determined depending on a helical twisted direction (sense) of the cholesteric liquid crystalline phase. Regarding the selective reflection of the circularly polarized light by the cholesteric liquid crystalline phase, in a case where the helical twisted direction of the cholesteric liquid crystal layer is right, right circularly polarized light is reflected, and in a case where the helical twisted direction of the cholesteric liquid crystal layer is left, left circularly polarized light is reflected.

A twisted direction of the cholesteric liquid crystalline phase can be adjusted by adjusting the kind of the liquid crystal compound that forms the cholesteric liquid crystal layer and/or the kind of the chiral agent to be added.

In addition, a half-width Δλ (nm) of a selective reflection wavelength range (circularly polarized light reflection wavelength range) where selective reflection is exhibited, that is, the half-width of the primary light depends on Δn of the cholesteric liquid crystalline phase and the helical pitch P and complies with a relationship of Δλ=Δn×P. Therefore, the width of the selective reflection wavelength range of the primary light can be controlled by adjusting Δn. Δn can be adjusted by adjusting a kind of a liquid crystal compound for forming the cholesteric liquid crystal layer and a mixing ratio thereof, and a temperature during alignment immobilization.

<<Method of Forming Cholesteric Liquid Crystal Layer>>

The cholesteric liquid crystal layer can be formed by immobilizing a cholesteric liquid crystalline phase in a layer shape.

The structure in which a cholesteric liquid crystalline phase is immobilized may be a structure in which the alignment of the liquid crystal compound as a cholesteric liquid crystalline phase is immobilized. Typically, the structure in which a cholesteric liquid crystalline phase is immobilized is preferably a structure which is obtained by making the polymerizable liquid crystal compound to be in a state where a cholesteric liquid crystalline phase is aligned, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

The structure in which a cholesteric liquid crystalline phase is immobilized is not particularly limited as long as the optical characteristics of the cholesteric liquid crystalline phase are maintained, and the liquid crystal compound 40 in the cholesteric liquid crystal layer does not necessarily exhibit liquid crystallinity. For example, the molecular weight of the polymerizable liquid crystal compound may be increased by a curing reaction such that the liquid crystallinity thereof is lost.

Examples of a material used for forming the cholesteric liquid crystal layer obtained by immobilizing a cholesteric liquid crystalline phase include a liquid crystal composition including a liquid crystal compound. It is preferable that the liquid crystal compound is a polymerizable liquid crystal compound.

In addition, the liquid crystal composition used for forming the cholesteric liquid crystal layer may further include a surfactant and a chiral agent.

—Polymerizable Liquid Crystal Compound—

The polymerizable liquid crystal compound may be a rod-shaped liquid crystal compound or a disk-shaped liquid crystal compound.

Examples of the rod-shaped polymerizable liquid crystal compound for forming the cholesteric liquid crystalline phase include a rod-shaped nematic liquid crystal compound. As the rod-shaped nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. Not only a low-molecular-weight liquid crystal compound but also a high-molecular-weight liquid crystal compound can be used.

The polymerizable liquid crystal compound can be obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3.

Examples of the polymerizable liquid crystal compound include compounds described in Makromol. Chem. (1989), Vol. 190, p. 2255, Advanced Materials (1993), Vol. 5, p. 107, U.S. Pat. Nos. 4,683,327A, 5,622,648A, 5,770,107A, WO95/22586, WO95/24455, WO97/00600, WO98/23580, WO98/52905, JP1989-272551A (JP-H1-272551A), JP1994-16616A (JP-H6-16616A), JP1995-110469A (JP-H7-110469A), JP1999-80081A (JP-H11-80081A), and JP2001-328973A. Two or more polymerizable liquid crystal compounds may be used in combination. In a case where two or more polymerizable liquid crystal compounds are used in combination, the alignment temperature can be decreased.

In addition, as a polymerizable liquid crystal compound other than the above-described examples, for example, a cyclic organopolysiloxane compound having a cholesteric phase described in JP1982-165480A (JP-S57-165480A) can be used. Further, as the above-described high-molecular-weight liquid crystal compound, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer described in JP1997-133810A (JP-H9-133810A), and a liquid crystal polymer described in JP1999-293252A (JP-H11-293252A) can be used.

—Disk-Shaped Liquid Crystal Compound—

As the disk-shaped liquid crystal compound, for example, compounds described in JP2007-108732A and JP2010-244038A can be preferably used.

In addition, the addition amount of the polymerizable liquid crystal compound in the liquid crystal composition is preferably 75 to 99.9 mass %, more preferably 80 to 99 mass %, and still more preferably 85 to 90 mass % with respect to the solid content mass (mass excluding a solvent) of the liquid crystal composition.

—Surfactant—

The liquid crystal composition used for forming the cholesteric liquid crystal layer may include a surfactant.

It is preferable that the surfactant is a compound that can function as an alignment control agent contributing to the stable or rapid alignment of a cholesteric liquid crystalline phase. Examples of the surfactant include a silicone surfactant and a fluorine-based surfactant. Among these, a fluorine-based surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and paragraphs “0082” to “0085” of JP2002-129162A, and fluorine (meth)acrylate polymers described in paragraphs “0018” to “0043” of JP2007-272185A.

As the surfactant, one kind may be used alone, or two or more kinds may be used in combination.

As the fluorine-based surfactant, a compound described in paragraphs “0082” to “0090” of JP2014-119605A is preferable.

The addition amount of the surfactant in the liquid crystal composition is preferably 0.01 to 10 mass %, more preferably 0.01 to 5 mass %, and still more preferably 0.02 to 1 mass % with respect to the total mass of the liquid crystal compound.

—Chiral Agent (Optically Active Compound)—

The chiral agent has a function of causing a helical structure of a cholesteric liquid crystalline phase to be formed. The chiral agent may be selected depending on the purpose because a helical twisted direction or a helical pitch derived from the compound varies.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, or an isomannide derivative can be used.

In general, the chiral agent includes an asymmetric carbon atom. However, an axially asymmetric compound or a planar asymmetric compound not having an asymmetric carbon atom can also be used as the chiral agent. Examples of the axially asymmetric compound or the planar asymmetric compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent includes a photoisomerization group, a pattern having a desired reflection wavelength corresponding to a luminescence wavelength can be formed by irradiation of an actinic ray or the like through a photomask after coating and alignment, which is preferable. As the photoisomerization group, an isomerization portion of a photochromic compound, an azo group, an azoxy group, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

The content of the chiral agent in the liquid crystal composition is preferably 0.01 to 200 mol % and more preferably 1 to 30 mol % with respect to the content molar amount of the liquid crystal compound.

—Polymerization Initiator—

In a case where the liquid crystal composition includes a polymerizable compound, it is preferable that the liquid crystal composition includes a polymerization initiator. In an aspect where a polymerization reaction progresses with ultraviolet irradiation, it is preferable that the polymerization initiator is a photopolymerization initiator which initiates a polymerization reaction with ultraviolet irradiation.

Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triarylimidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

In particular, it is preferable that the polymerization initiator is a dichroic polymerization initiator.

The dichroic polymerization initiator refers to a polymerization initiator that has absorption selectivity with respect to light in a specific polarization direction and is excited by the polarized light to generate a free radical among photopolymerization initiators. That is, the dichroic polymerization initiator refers to a polymerization initiator having different absorption selectivities between light in a specific polarization direction and light in a polarization direction perpendicular to the light in the specific polarization direction.

The details and specific examples are described in the pamphlet of WO2003/054111.

Specific examples of the dichroic polymerization initiator include polymerization initiators represented by the following chemical formulae. In addition, as the dichroic polymerization initiator, a polymerization initiator described in paragraphs “0046” to “0097” of JP2016-535863A.

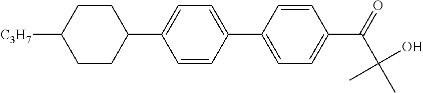

The content of the photopolymerization initiator in the liquid crystal composition is preferably 0.1 to 20 mass % and more preferably 0.5 to 12 mass % with respect to the content of the liquid crystal compound.

—Crosslinking Agent—

In order to improve the film hardness after curing and to improve durability, the liquid crystal composition may optionally include a crosslinking agent. As the crosslinking agent, a curing agent which can perform curing with ultraviolet light, heat, moisture, or the like can be suitably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris[3-(1-aziridinyl)propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof; and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. Among these crosslinking agents, one kind may be used alone, or two or more kinds may be used in combination.

The content of the crosslinking agent is preferably 3 to 20 mass % and more preferably 5 to 15 mass % with respect to the solid content mass of the liquid crystal composition. In a case where the content of the crosslinking agent is in the above-described range, an effect of improving a crosslinking density can be easily obtained, and the stability of a cholesteric liquid crystalline phase is further improved.

—Other Additives—

Optionally, a polymerization inhibitor, an antioxidant, an ultraviolet absorber, a light stabilizer, a coloring material, metal oxide particles, or the like can be added to the liquid crystal composition in a range where optical performance and the like do not deteriorate.

In a case where the cholesteric liquid crystal layer is formed, it is preferable that the liquid crystal composition is used as liquid.

The liquid crystal composition may include a solvent. The solvent is not particularly limited and can be appropriately selected depending on the purpose. An organic solvent is preferable.

The organic solvent is not particularly limited and can be appropriately selected depending on the purpose. Examples of the organic solvent include a ketone, an alkyl halide, an amide, a sulfoxide, a heterocyclic compound, a hydrocarbon, an ester, and an ether. Among these organic solvents, one kind may be used alone, or two or more kinds may be used in combination. Among these, a ketone is preferable in consideration of an environmental burden.

In a case where the cholesteric liquid crystal layer is formed, it is preferable that the cholesteric liquid crystal layer is formed by applying the liquid crystal composition to a surface where the cholesteric liquid crystal layer is to be formed, aligning the liquid crystal compound to a state of a cholesteric liquid crystalline phase, and curing the liquid crystal compound.

That is, in a case where the cholesteric liquid crystal layer is formed on the alignment film 32, it is preferable that the cholesteric liquid crystal layer obtained by immobilizing a cholesteric liquid crystalline phase is formed by applying the liquid crystal composition to the alignment film 32, aligning the liquid crystal compound to a state of a cholesteric liquid crystalline phase, and curing the liquid crystal compound.

For the application of the liquid crystal composition, a printing method such as ink jet or scroll printing or a well-known method such as spin coating, bar coating, or spray coating capable of uniformly applying liquid to a sheet-shaped material can be used.

The applied liquid crystal composition is optionally dried and/or heated and then is cured to form the cholesteric liquid crystal layer. In the drying and/or heating step, the liquid crystal compound in the liquid crystal composition may be aligned to a cholesteric liquid crystalline phase. In the case of heating, the heating temperature is preferably 200° C. or lower and more preferably 130° C. or lower.

The aligned liquid crystal compound is optionally further polymerized. Regarding the polymerization, thermal polymerization or photopolymerization using light irradiation may be performed, and photopolymerization is preferable. Regarding the light irradiation, ultraviolet light is preferably used. The irradiation energy is preferably 20 mJ/cm² to 50 J/cm² and more preferably 50 to 1500 mJ/cm². In order to promote a photopolymerization reaction, light irradiation may be performed under heating conditions or in a nitrogen atmosphere. The wavelength of irradiated ultraviolet light is preferably 250 to 430 nm.

The thickness of the cholesteric liquid crystal layer is not particularly limited, and the thickness with which a required light reflectivity can be obtained may be appropriately set depending on the use of the cholesteric liquid crystal layer, the light reflectivity required for the cholesteric liquid crystal layer, the material for forming the cholesteric liquid crystal layer, and the like.

(Liquid Crystal Elastomer)

A liquid crystal elastomer may be used for the cholesteric liquid crystal layer according to the embodiment of the present invention. The liquid crystal elastomer is a hybrid material of liquid crystal and an elastomer. For example, the liquid crystal elastomer has a structure in which a liquid crystalline rigid mesogenic group is introduced into a flexible polymer network having rubber elasticity. Therefore, the liquid crystal elastomer has flexible mechanical characteristics and elasticity. In addition, the alignment state of liquid crystal and the macroscopic shape of the system strongly correlate to each other. In a state where the alignment state of liquid crystal changes depending on a temperature, an electric field, or the like, macroscopic deformation corresponding to a change in alignment degree occurs. For example, in a case where the liquid crystal elastomer is heated up to a temperature at which a nematic phase is transformed into an isotropic phase of random alignment, a sample contracts in a director direction, and the contraction amount thereof increases along with a temperature increase, that is, the alignment degree of liquid crystal decreases. The deformation is thermoreversible, and the liquid crystal elastomer returns to its original shape in a case where it is cooled to the temperature of the nematic phase again. On the other hand, in a case where the liquid crystal elastomer of the cholesteric phase is heated such that the alignment degree of liquid crystal decreases, the macroscopic elongational deformation of the helical axis direction occurs. Therefore, the helical pitch length increases, and the reflection center wavelength of the selective reflection peak is shifted to a longer wavelength side. This change is also thermoreversible, and as the liquid crystal elastomer is cooled, the reflection center wavelength returns to a shorter wavelength side.

<<Liquid Crystal Alignment Pattern of Cholesteric Liquid Crystal Layer>>

As described above, in the cholesteric liquid crystal layer, the cholesteric liquid crystal layer has the liquid crystal alignment pattern in which the direction of the optical axis 40A derived from the liquid crystal compound 40 forming the cholesteric liquid crystalline phase changes while continuously rotating in the one in-plane direction of the cholesteric liquid crystal layer.

The optical axis 40A derived from the liquid crystal compound 40 is an axis having the highest refractive index in the liquid crystal compound 40, that is, a so-called slow axis. For example, in a case where the liquid crystal compound 40 is a rod-shaped liquid crystal compound, the optical axis 40A is along a rod-shaped major axis direction. In the following description, the optical axis 40A derived from the liquid crystal compound 40 will also be referred to as “the optical axis 40A of the liquid crystal compound 40” or “the optical axis 40A”.

FIG. 4 conceptually shows a plan view of the cholesteric liquid crystal layer 18.

The plan view is a view in a case where the cholesteric liquid crystal layer is seen from the top in FIG. 3, that is, a view in a case where the cholesteric liquid crystal layer is seen from a thickness direction (laminating direction of the respective layers (films)).

In addition, in FIG. 4, in order to clarify the configuration of the cholesteric liquid crystal layer (cholesteric liquid crystal layer 18), only the liquid crystal compound 40 on the surface of the alignment film 32 is shown.

As shown in FIG. 4, on the surface of the alignment film 32, the liquid crystal compound 40 forming the cholesteric liquid crystal layer 18 has the liquid crystal alignment pattern in which the direction of the optical axis 40A changes while continuously rotating in the predetermined one in-plane direction indicated by arrow X1 in a plane of the cholesteric liquid crystal layer according to the alignment pattern formed on the alignment film 32 as the lower layer. In the example shown in the drawing, the liquid crystal compound 40 has the liquid crystal alignment pattern in which the optical axis 40A of the liquid crystal compound 40 changes while continuously rotating clockwise in the arrow X1 direction.

The liquid crystal compound 40 forming the cholesteric liquid crystal layer 18 is two-dimensionally arranged in a direction perpendicular to the arrow X1 and the one in-plane direction (arrow X1 direction).

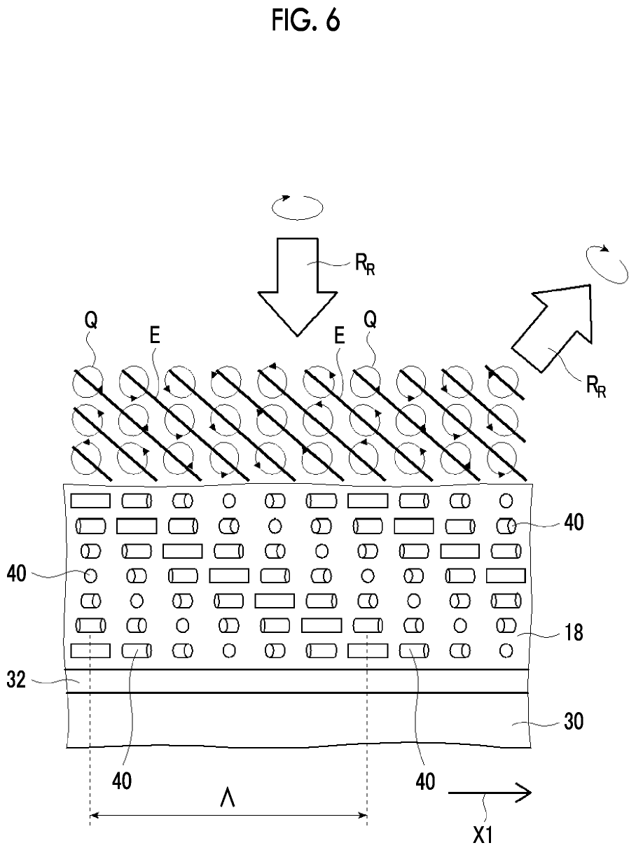

In the following description, the direction perpendicular to the arrow X1 direction will be referred to as “Y direction” for convenience of description. That is, the arrow Y direction is a direction perpendicular to the one in-plane direction in which the direction of the optical axis 40A of the liquid crystal compound 40 changes while continuously rotating in a plane of the cholesteric liquid crystal layer. Accordingly, in FIGS. 3 and 6 described below, the Y direction is a direction perpendicular to the paper plane.

Specifically, “the direction of the optical axis 40A of the liquid crystal compound 40 changes while continuously rotating in the arrow X1 direction (the predetermined one in-plane direction)” represents that an angle between the optical axis 40A of the liquid crystal compound 40, which is arranged in the arrow X1 direction, and the arrow X1 direction varies depending on positions in the arrow X1 direction, and the angle between the optical axis 40A and the arrow X1 direction sequentially changes from θ to θ+180° or θ−180° in the arrow X1 direction.

A difference between the angles of the optical axes 40A of the liquid crystal compound 40 adjacent to each other in the arrow X1 direction is preferably 45° or less, more preferably 15° or less, and still more preferably less than 15°.

On the other hand, in the liquid crystal compound 40 forming the cholesteric liquid crystal layer 18, the directions of the optical axes 40A are the same in the Y direction perpendicular to the arrow X1 direction, that is, the Y direction perpendicular to the one in-plane direction in which the optical axis 40A continuously rotates.

In other words, in the liquid crystal compound 40 forming the cholesteric liquid crystal layer 18, angles between the optical axes 40A of the liquid crystal compound 40 and the arrow X1 direction are the same in the Y direction.

In the cholesteric liquid crystal layer 18, in the liquid crystal alignment pattern of the liquid crystal compound 40, the length (distance) over which the optical axis 40A of the liquid crystal compound 40 rotates by 180° in the arrow X1 direction in which the optical axis 40A changes while continuously rotating in a plane is the length Λ of the single period in the liquid crystal alignment pattern.

That is, a distance between centers of two liquid crystal compounds 40 in the arrow X1 direction is the length Λ of the single period, the two liquid crystal compounds having the same angle in the arrow X1 direction. Specifically, as shown in FIG. 4, a distance of centers in the arrow X1 direction of two liquid crystal compounds 40 in which the arrow X1 direction and the direction of the optical axis 40A match each other is the length Λ of the single period. In the following description, the length Λ of the single period will also be referred to as “single period Λ”.

In the liquid crystal alignment pattern of the cholesteric liquid crystal layer 18, the single period Λ is repeated in the arrow X1 direction, that is, in the one in-plane direction in which the direction of the optical axis 40A changes while continuously rotating.

The cholesteric liquid crystal layer obtained by immobilizing a cholesteric liquid crystalline phase typically reflects incident light (circularly polarized light) by specular reflection.

On the other hand, the cholesteric liquid crystal layer 18 reflects incident light in a state where it is tilted in the arrow X1 direction with respect to the specular reflection. The cholesteric liquid crystal layer 18 has the liquid crystal alignment pattern in which the optical axis 40A changes while continuously rotating in the arrow X1 direction in a plane (the predetermined one in-plane direction). Hereinafter, the description will be made with reference to FIG. 6.

For example, the cholesteric liquid crystal layer 18 selectively reflects right circularly polarized light R_{R} of red light. Accordingly, in a case where light is incident into the cholesteric liquid crystal layer 18, the cholesteric liquid crystal layer 18 reflects only right circularly polarized light R_{R} of red light and allows transmission of the other light.

In a case where the right circularly polarized light R_{R} of red light incident into the cholesteric liquid crystal layer 18 is reflected from the cholesteric liquid crystal layer, the absolute phase changes depending on the directions of the optical axes 40A of the respective liquid crystal compounds 40.

Here, in the cholesteric liquid crystal layer 18, the optical axis 40A of the liquid crystal compound 40 changes while rotating in the arrow X1 direction (the one in-plane direction). Therefore, the amount of change in the absolute phase of the incident right circularly polarized light R_{R} of red light varies depending on the directions of the optical axes 40A.

Further, the liquid crystal alignment pattern formed in the cholesteric liquid crystal layer 18 is a pattern that is periodic in the arrow X1 direction. Therefore, as conceptually shown in FIG. 6, an absolute phase Q that is periodic in the arrow X1 direction corresponding to the direction of the optical axis 40A is assigned to the right circularly polarized light R_{R} of red light incident into the cholesteric liquid crystal layer 18.

In addition, the direction of the optical axis 40A of the liquid crystal compound 40 with respect to the arrow X1 direction is uniform in the arrangement of the liquid crystal compound 40 in the Y direction perpendicular to arrow X1 direction.

As a result, in the cholesteric liquid crystal layer 18, an equiphase surface E that is tilted in the arrow X1 direction with respect to an XY plane is formed for the right circularly polarized light R_{R} of red light.

Therefore, the right circularly polarized light R_{R} of red light is reflected in the normal direction of the equiphase surface E, and the reflected right circularly polarized light R_{R} of red light is reflected in a direction that is tilted in the arrow X1 direction with respect to the XY plane (main surface of the cholesteric liquid crystal layer).

Accordingly, by appropriately setting the arrow X1 direction as the one in-plane direction in which the optical axis 40A rotates, a direction in which the right circularly polarized light R_{R} of red light is reflected can be adjusted.

That is, by reversing the arrow X1 direction, the reflection direction of the right circularly polarized light R_{R} of red light is opposite to that of FIG. 6.

In addition, by reversing the rotation direction of the optical axis 40A of the liquid crystal compound 40 toward the arrow X1 direction, a reflection direction of the right circularly polarized light R_{R} of red light can be reversed.

That is, in FIGS. 4 and 6, the rotation direction of the optical axis 40A toward the arrow X1 direction is clockwise, and the right circularly polarized light R_{R} of red light is reflected in a state where it is tilted in the arrow X1 direction. By setting the rotation direction of the optical axis 40A to be counterclockwise, the right circularly polarized light R_{R} of red light is reflected in a state where it is tilted in a direction opposite to the arrow X1 direction.

Further, in the cholesteric liquid crystal layer having the same liquid crystal alignment pattern, the reflection direction is reversed by adjusting the helical turning direction of the liquid crystal compound 40, that is, the turning direction of circularly polarized light to be reflected.

The cholesteric liquid crystal layer 18 shown in FIG. 6 has a right-twisted helical turning direction, selectively reflects right circularly polarized light, and has the liquid crystal alignment pattern in which the optical axis 40A rotates clockwise in the arrow X1 direction. As a result, the right circularly polarized light is reflected in a state where it is tilted in the arrow X1 direction.

Accordingly, in the cholesteric liquid crystal layer that has a left-twisted helical turning direction, selectively reflects left circularly polarized light, and has the liquid crystal alignment pattern in which the optical axis 40A rotates clockwise in the arrow X1 direction, the left circularly polarized light is reflected in a state where it is tilted in a direction opposite to the arrow X1 direction.

In the cholesteric liquid crystal layer having the liquid crystal alignment pattern, as the single period Λ decreases, the angle of reflected light with respect to the above-described incidence light increases. That is, as the single period Λ decreases, reflected light can be reflected in a state where it is largely tilted with respect to incidence light.

<<Refractive Index Ellipsoid of Cholesteric Liquid Crystal Layer>>

As described above, the cholesteric liquid crystal layer 18 has the refractive index ellipsoid having the configuration in which, in a case where the arrangement of the liquid crystal compound 40 is seen from the helical axis direction, an angle between the molecular axes of the liquid crystal compounds 40 adjacent to each other gradually changes.

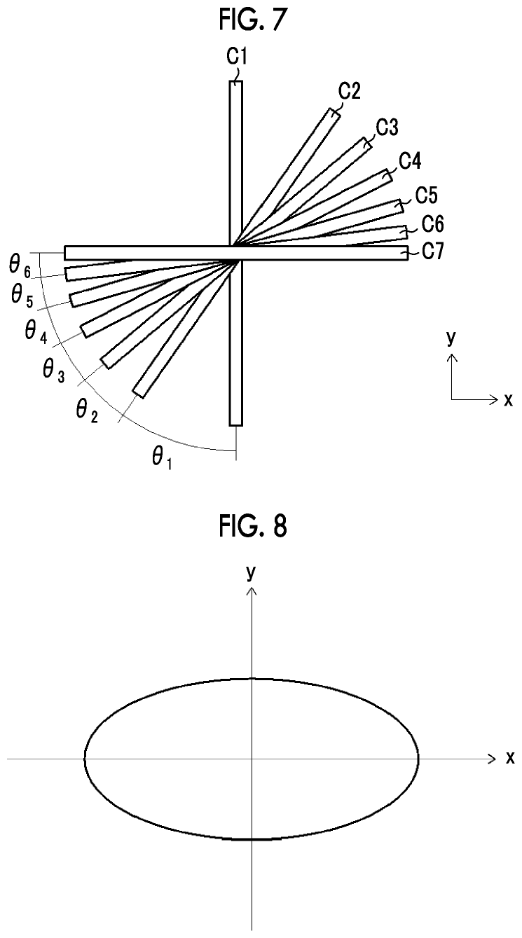

The refractive index ellipsoid will be described using FIGS. 7 and 8.

FIG. 7 is a diagram showing a part (¼ pitch portion) of a plurality of liquid crystal compounds that are twisted and aligned along a helical axis in case of being seen from a helical axis direction (y direction). FIG. 8 is a diagram conceptually showing an existence probability of the liquid crystal compound seen from the helical axis direction.

In FIG. 7, a liquid crystal compound having a molecular axis parallel to the y direction is represented by C1, a liquid crystal compound having a molecular axis parallel to the x direction is represented by C7, and liquid crystal compounds between C1 and C7 are represented by C2 to C6 in order from the liquid crystal compound C1 side to the liquid crystal compound C7 side. The liquid crystal compounds C1 to C7 are twisted and aligned along the helical axis, and the liquid crystal compound rotates by 90° from the liquid crystal compound C1 to the liquid crystal compound C7. In a case where the length between the liquid crystal compounds over which the angle of the liquid crystal compound that is twisted and aligned changes by 360° is set as 1 pitch (“P” in FIG. 2), the length between the liquid crystal compound C1 and the liquid crystal compound C7 is set as ¼ pitch.

As shown in FIG. 7, in the ¼ pitch from the liquid crystal compound C1 to the liquid crystal compound C7, the angle between the molecular axes of the liquid crystal compounds adjacent to each other in case of being seen from the z direction (helical axis direction) varies. In the example shown in FIG. 7, an angle θ₁ between the liquid crystal compound C1 and the liquid crystal compound C2 is more than an angle θ₂ between the liquid crystal compound C2 and the liquid crystal compound C3, the angle θ₂ between the liquid crystal compound C2 and the liquid crystal compound C3 is more than an angle θ₃ between the liquid crystal compound C3 and the liquid crystal compound C4, the angle θ₃ between the liquid crystal compound C3 and the liquid crystal compound C4 is more than an angle θ₄ between the liquid crystal compound C4 and the liquid crystal compound C5, the angle θ₄ between the liquid crystal compound C4 and the liquid crystal compound C5 is more than an angle θ₅ between the liquid crystal compound C5 and the liquid crystal compound C6, the angle θ₅ between the liquid crystal compound C5 and the liquid crystal compound C6 is more than an angle θ₆ between the liquid crystal compound C6 and the liquid crystal compound C7, and the angle θ₆ between the liquid crystal compound C6 and the liquid crystal compound C7 is the smallest.

That is, the liquid crystal compounds C1 to C7 are twisted and aligned such that the angle between the molecular axes of the liquid crystal compounds adjacent to each other decreases in order from the liquid crystal compound C1 side toward the liquid crystal compound C7 side.

For example, in a case where the interval between the liquid crystal compounds (the interval in the thickness direction) is substantially regular, the rotation angle per unit length decreases in order from the liquid crystal compound C1 side to the liquid crystal compound C7 side in the ¼ pitch from the liquid crystal compound C1 to the liquid crystal compound C7.

In the cholesteric liquid crystal layer 18, the configuration in which the rotation angle per unit length changes as described above in the ¼ pitch is repeated such that the liquid crystal compound is twisted and aligned.

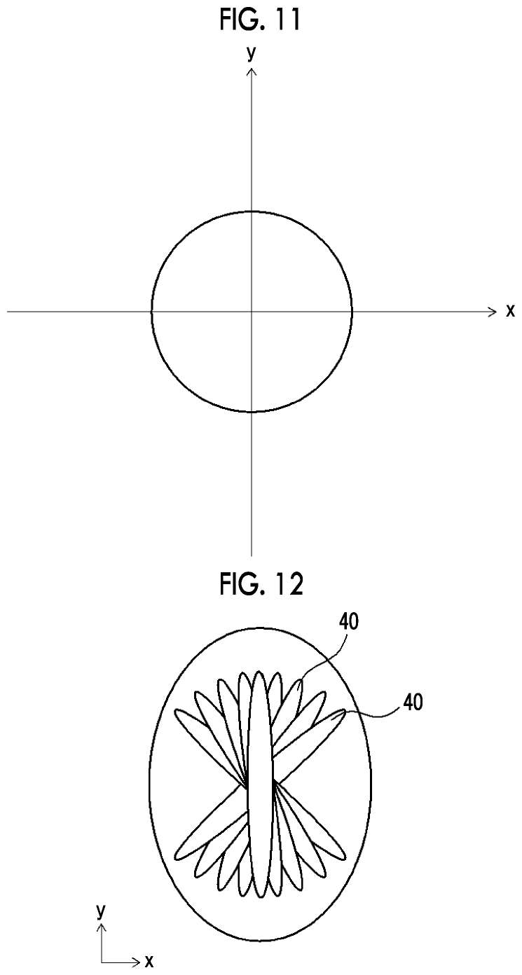

Here, in a case where the rotation angle per unit length is constant, the angle between the molecular axes of the liquid crystal compounds adjacent to each other is constant. Therefore, as conceptually shown in FIG. 11, the existence probability of the liquid crystal compound in case of being seen from the helical axis direction is the same in any direction.

On the other hand, as described above, with the rotation angle per unit length decreases in order from the liquid crystal compound C1 side to the liquid crystal compound C7 side in the ¼ pitch from the liquid crystal compound C1 to the liquid crystal compound C7, the existence probability of the liquid crystal compound in case of being seen from the helical axis direction in the x direction is higher than that in the y direction as conceptually shown in FIG. 8. By making the existence probability of the liquid crystal compound to vary between the x direction and the y direction, the refractive index varies between the x direction and the y direction such that refractive index anisotropy occurs. In other words, refractive index anisotropy in a plane perpendicular to the helical axis occurs.

The refractive index nx in the x direction in which the existence probability of the liquid crystal compound is higher is higher than the refractive index ny in the y direction in which the existence probability of the liquid crystal compound is lower. Accordingly, the refractive index nx and the refractive index ny satisfy nx>ny.

The x direction in which the existence probability of the liquid crystal compound is higher is the in-plane slow axis direction of the cholesteric liquid crystal layer 18, and the y direction in which the existence probability of the liquid crystal compound is lower is the in-plane fast axis direction of the cholesteric liquid crystal layer 18.

This way, the configuration (the configuration having the refractive index ellipsoid) in which the rotation angle per unit length in the ¼ pitch change in the twisted alignment of the liquid crystal compound can be formed by applying a composition for forming the cholesteric liquid crystal layer and irradiating the cholesteric liquid crystalline phase (composition layer) with polarized light in a direction perpendicular to the helical axis.

The cholesteric liquid crystalline phase can be distorted by photo alignment by polarized light irradiation to cause in-plane retardation to occur. That is, refractive index nx>refractive index ny can be satisfied.

Specifically, the polymerization of the liquid crystal compound having a molecular axis in a direction that matches a polarization direction of irradiated polarized light progresses. At this time, only a part of the liquid crystal compound is polymerized. Therefore, a chiral agent present at this position is excluded and moves to another position.

Accordingly, at a position where the direction of the molecular axis of the liquid crystal compound is close to the polarization direction, the amount of the chiral agent decreases, and the rotation angle of the twisted alignment decreases. On the other hand, at a position where the direction of the molecular axis of the liquid crystal compound is perpendicular to the polarization direction, the amount of the chiral agent increases, and the rotation angle of the twisted alignment increases.

As a result, as shown in FIG. 7, the liquid crystal compound that is twisted and aligned along the helical axis can be configured such that, in the ¼ pitch from the liquid crystal compound having the molecular axis parallel to the polarization direction to the liquid crystal compound having the molecular axis perpendicular to the polarization direction, the angle between the molecular axes of the liquid crystal compounds adjacent to each other decreases in order from the liquid crystal compound side parallel to the polarization direction to the liquid crystal compound side perpendicular to the polarization direction. That is, by irradiating the cholesteric liquid crystalline phase with polarized light, the existence probability of the liquid crystal compound varies between the x direction and the y direction, the refractive index varies between the x direction and the y direction such that refractive index anisotropy occurs. As a result, the refractive index nx and the refractive index ny of the optical element 10 can satisfy nx>ny. That is, the cholesteric liquid crystal layer can adopt the configuration having the refractive index ellipsoid.

This polarized light irradiation may be performed at the same time as the immobilization of the cholesteric liquid crystalline phase, the immobilization may be further performed by non-polarized light irradiation after the polarized light irradiation, and photo alignment may be performed by polarized light irradiation after performing the immobilization by non-polarized light irradiation. In order to obtain high retardation, it is preferable that only polarized light irradiation is performed or polarized light irradiation is performed in advance. It is preferable to perform the polarized light irradiation in an inert gas atmosphere where the oxygen concentration is 0.5% or less. The irradiation energy is preferably 20 mJ/cm² to 10 J/cm² and more preferably 100 to 800 mJ/cm². The illuminance is preferably 20 to 1000 mW/cm², more preferably 50 to 500 mW/cm², and still more preferably 100 to 350 mW/cm². The kind of the liquid crystal compound to be cured by polarized light irradiation is not particularly limited, and a liquid crystal compound having an ethylenically unsaturated group as a reactive group is preferable.

In addition, examples of a method of distorting the cholesteric liquid crystalline phase by polarized light irradiation to cause in-plane retardation to occur include a method using a dichroic liquid crystalline polymerization initiator (WO03/054111A1) and a method using a rod-shaped liquid crystal compound having a photo-alignable functional group such as a cinnamoyl group in the molecule (JP2002-6138A).

The light to be irradiated may be ultraviolet light, visible light, or infrared light. That is, the light with which the liquid crystal compound is polymerizable may be appropriately selected depending on the liquid crystal compound including a coating film, the polymerization initiator, and the like.

In a case where the composition layer is irradiated with polarized light by using the dichroic polymerization initiator as the polymerization initiator, the polymerization of the liquid crystal compound having a molecular axis in a direction that matches the polarization direction can be more suitably made to progress.

The in-plane slow axis direction, the in-plane fast axis direction, the refractive index nx, and the refractive index ny can be measured using M-2000 UI (manufactured by J. A. Woollam Co., Ltd.) as a spectroscopic ellipsometer. The refractive index nx and the refractive index ny can be obtained from a measured value of a phase difference Δn×d using measured values of an average refractive index nave and a thickness d. Here, Δn=nx−ny, and the average refractive index nave=(nx+ny)/2. In general, since the average refractive index of liquid crystal is about 1.5, nx and ny can be obtained using this value. In addition, the in-plane slow axis direction, the in-plane fast axis direction, the refractive index nx, and the refractive index ny of the cholesteric liquid crystal layer used in the present invention are measured, a wavelength (for example, a wavelength 100 nm longer than a longer wavelength side end of the selective wavelength; in the present invention, 1000 nm) longer than the selective reflection wavelength (in the case of the present invention, the selective reflection wavelength of the primary light) is set as a measurement wavelength. As a result, the influence of retardation derived from the cholesteric selective reflection on a rotary polarization component is reduced as far as possible. Therefore, the measurement can be performed with high accuracy.

In addition, the cholesteric liquid crystal layer having the refractive index ellipsoid can be formed by stretching the cholesteric liquid crystal layer after applying the composition for forming the cholesteric liquid crystal layer, after immobilizing the cholesteric liquid crystalline phase, or in a state where the cholesteric liquid crystalline phase is semi-immobilized.

In a case where the cholesteric liquid crystal layer having the refractive index ellipsoid is formed by stretching, the stretching may be monoaxial stretching or biaxial stretching. In addition, stretching conditions may be appropriately set depending on the material, the thickness, the desired refractive index nx, and the desired refractive index ny of the cholesteric liquid crystal layer. In the case of monoaxial stretching, the stretching ratio is preferably 1.1 to 4. In the case of biaxial stretching, a ratio between the stretching ratio of one stretching direction and the stretching ratio of another stretching direction is preferably 1.1 to 2.

<<Action of Cholesteric Liquid Crystal Layer>>

An action of the cholesteric liquid crystal layer (optical element) having the above-described configuration will be described below in detail.

As shown in FIG. 1, in a case where light L₁ is incident into the cholesteric liquid crystal layer 18 having the liquid crystal alignment pattern from a direction perpendicular to a main surface, as described above, the light L₁ is reflected as light L₂ in a tilted direction by an equiphase surface E that is formed by the alignment of the liquid crystal compound in the cholesteric liquid crystal layer 18. The light L₂ is primary light of reflected light from a cholesteric liquid crystal layer 100 (hereinafter, also referred to as “primary reflected light”). The reflection angle θ of the primary reflected light is given from θ=a sin (mλ/p) in a case where the incidence direction is the normal direction. Here, m represents a degree, in which m=1 in the case of primary light and m=2 in the case of secondary light, λ represents a wavelength, and p represents an in-plane period length.

Here, according to an investigation by the present inventors, it was found that, in a case where the cholesteric liquid crystal layer 18 has the refractive index ellipsoid, not only the primary reflected light L₂ but also secondary light (hereinafter, also referred to as secondary reflected light) L₃ are reflected. In addition, it was found that the secondary reflected light has the following characteristics.

The center wavelength of the secondary reflected light has a length that is about half of the length of the selective reflection center wavelength of the primary reflected light. In addition, the bandwidth (half-width) of the secondary reflected light is less than the bandwidth of the primary reflected light. In addition, since the wavelength of the secondary reflected light has a length that is about half of the length of the primary reflected light. As can be understood from the above-described expression θ=a sin (mλ/p), the configuration in which m is doubled from 1 to 2 and the configuration in which the wavelength of the primary reflected light is half of that of the secondary reflected light are offset from each other such that the diffraction angle of the secondary reflected light is reflected at substantially the same angle as that the primary reflected light. In addition, although the primary reflected light is any of right circularly polarized light or left circularly polarized light depending on the turning direction of the cholesteric liquid crystalline phase, the secondary reflected light includes both components of right circularly polarized light and left circularly polarized light.

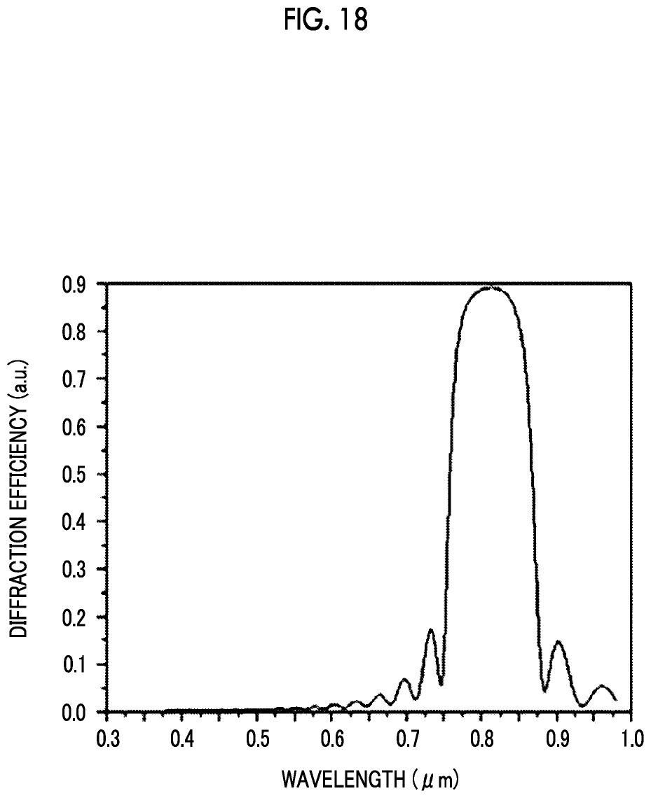

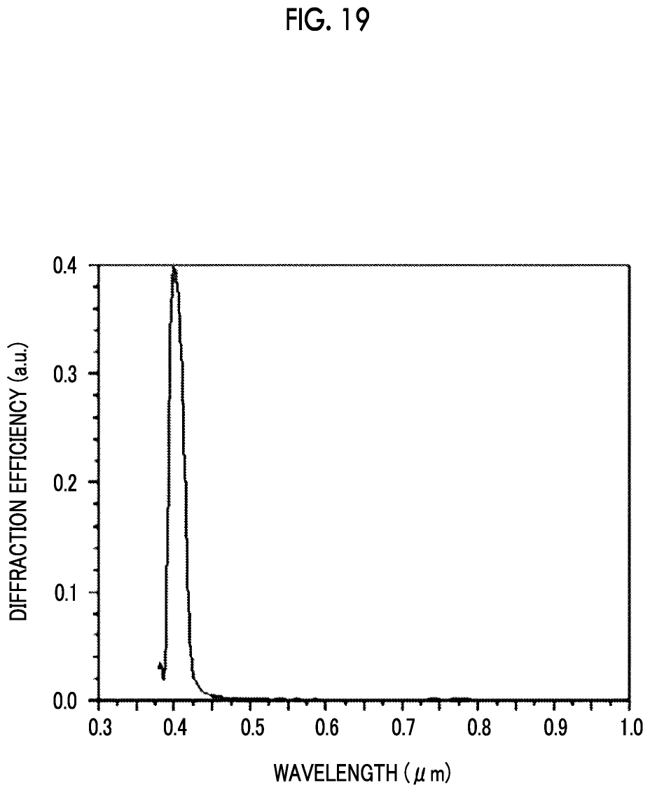

For example, FIG. 18 is a graph showing a relationship between a wavelength and a diffraction efficiency (light amount) of the primary reflected light measured in Example 1 described below. FIG. 19 is a graph showing a relationship between a wavelength and a diffraction efficiency of the secondary reflected light. The reflection angle in FIGS. 18 and 19 is measured as an angle corresponding to the above-described expression θ=a sin (mλ/p).

As shown in FIG. 18, light in a specific wavelength range is measured. This light is primary reflected light, and the center wavelength thereof is about 800 nm. In addition, the half-width is 90 nm. The diffraction angle varies depending on the wavelength and, for example, is 24.3° at 780 nm, is 25° at 800 nm, and is 25.7° at 820 nm. On the other hand, as shown in FIG. 19, the secondary reflected light is measured in another wavelength range, and the center wavelength thereof is about 400 nm. In addition, the half-width is 25 nm. This diffraction angle is 25° at 400 nm.

On the other hand, in a cholesteric liquid crystal layer having a liquid crystal alignment pattern in the related art, as shown in FIG. 10, in a case where the arrangement of liquid crystal compounds 102 is seen from the helical axis direction, an angle between molecular axes of liquid crystal compounds 102 adjacent to each other is constant. That is, the cholesteric liquid crystal layer does not have the refractive index ellipsoid. Therefore, as conceptually shown in FIG. 11, the existence probability of the liquid crystal compound in case of being seen from the helical axis direction is the same in any direction.

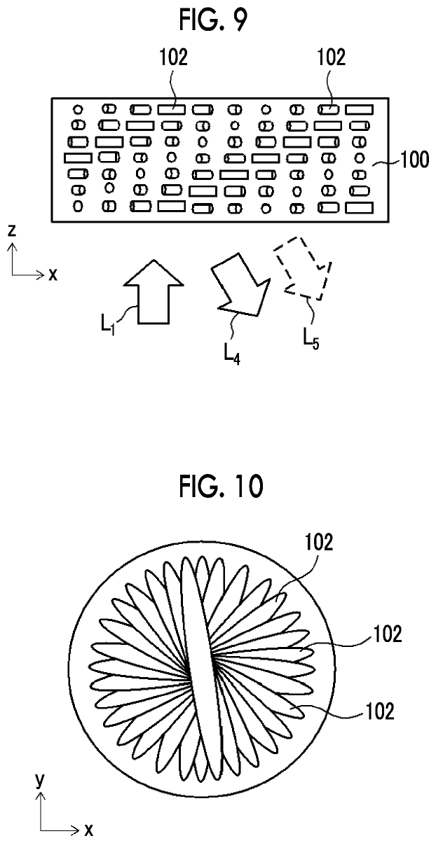

As shown in FIG. 9, in a case where light L₁ is incident into the cholesteric liquid crystal layer 100 in the related art from a direction perpendicular to a main surface, as described above, the light L₁ is reflected as light L₄ in a tilted direction by an equiphase surface that is formed by the alignment of the liquid crystal compound in the cholesteric liquid crystal layer 100. The light L₄ is primary reflected light from the cholesteric liquid crystal layer 100. On the other hand, the secondary reflected light L₅ is not reflected.

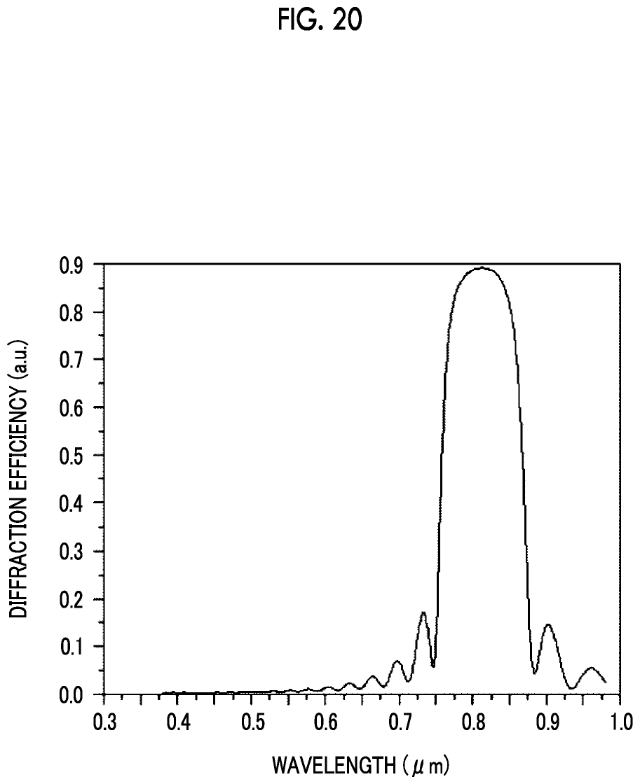

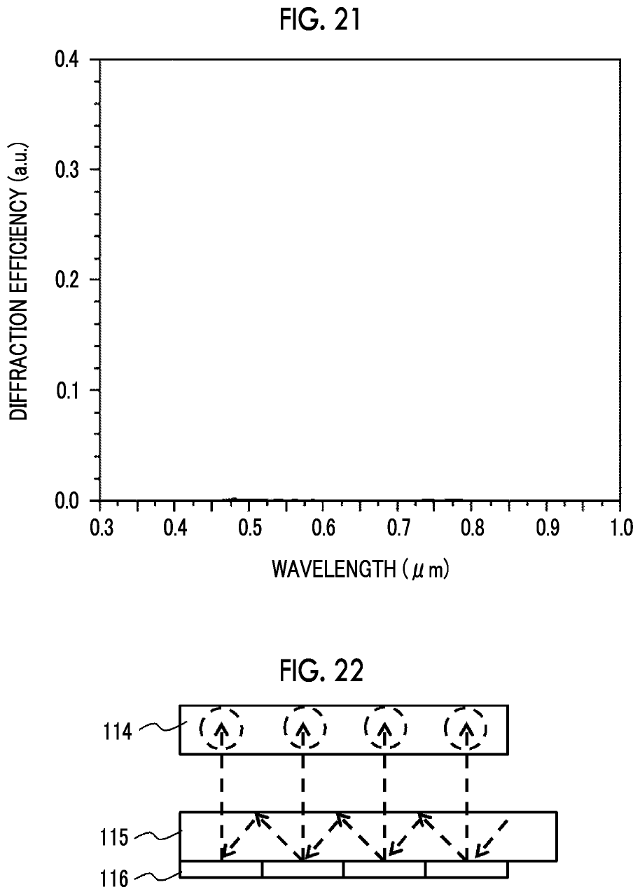

For example, FIG. 20 is a graph showing a relationship between a wavelength and a diffraction efficiency (light amount) of the primary reflected light measured in Comparative Example 1 described below. FIG. 21 is a graph showing a relationship between a wavelength and a diffraction efficiency of the secondary reflected light.

As shown in FIG. 20, light in a specific wavelength range is measured. This light is primary reflected light, and the center wavelength thereof is about 800 nm. In addition, the half-width is 90 nm. The diffraction angle varies depending on the wavelength and, for example, is 24.3° at 780 nm, is 25° at 800 nm, and is 25.7° at 820 nm. On the other hand, as shown in FIG. 21, the secondary reflected light is not substantially measured.

This way, in the optical element according to the embodiment of the present invention, the secondary reflected light is reflected in the same direction as that of the primary reflected light. The secondary reflected light is light having a wavelength (substantially half) that is largely different from that of the primary reflected light in a much narrower wavelength range than that of the primary reflected light. Accordingly, the optical element according to the embodiment of the present invention can be used as an optical element with which reflected light in a narrower wavelength range can be obtained using the secondary reflected light.

Here, from the viewpoint of further reducing the bandwidth (half-width) of the secondary reflected light, the in-plane retardation (nx−ny)×d is preferably 30 nm or more, more preferably 30 nm or more and 200 nm or less, still more preferably 47 nm or more and 200 nm or less, and still more preferably 80 nm or more and 160 nm or less.

In addition, in the example shown in FIG. 2, the existence probability of the liquid crystal compound is high in the x direction, that is, in the direction in which the direction of the optical axis of the liquid crystal compound changes while continuously rotating in the liquid crystal alignment pattern, and the existence probability in the y direction is low. That is, the direction in which the direction of the optical axis of the liquid crystal compound changes while continuously rotating in the liquid crystal alignment pattern matches the in-plane slow axis direction is adopted, but the present invention is not limited thereto. A relationship between the direction in which the direction of the optical axis of the liquid crystal compound changes while continuously rotating in the liquid crystal alignment pattern and the in-plane slow axis direction is not particularly limited.

For example, in the example shown in FIG. 12, the existence probability of the liquid crystal compound may be set to be high in the y direction perpendicular to the direction in which the direction of the optical axis of the liquid crystal compound changes while continuously rotating in the liquid crystal alignment pattern, and the existence probability in the x direction may be set to be low. That is, the direction in which the direction of the optical axis of the liquid crystal compound changes while continuously rotating in the liquid crystal alignment pattern may be substantially perpendicular to the in-plane slow axis direction.

Here, the cholesteric liquid crystal layer 18 shown in FIG. 3 has the configuration in which the optical axis of the liquid crystal compound is parallel to the main surface of the cholesteric liquid crystal layer, but the present invention is not limited thereto.

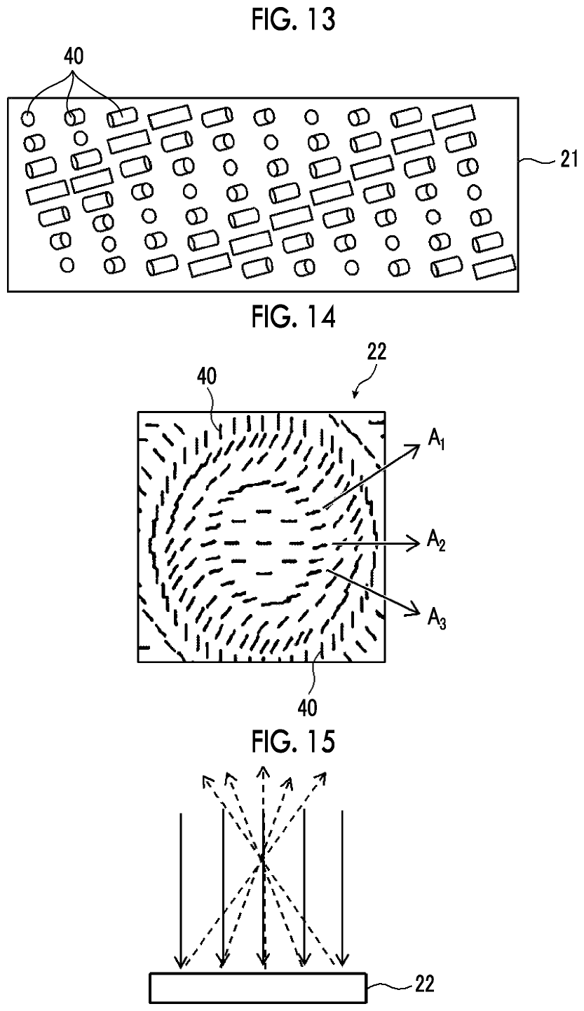

For example, as in a cholesteric liquid crystal layer 21 shown in FIG. 13, in the above-described cholesteric liquid crystal layer, the optical axis of the liquid crystal compound may be tilted to the main surface of the liquid crystal layer (cholesteric liquid crystal layer). The cholesteric liquid crystal layer 21 is the same as the cholesteric liquid crystal layer 18 in that they have the liquid crystal alignment pattern in which the direction of the optical axis derived from the liquid crystal compound changes while continuously rotating in the one in-plane direction. That is, the plan view of the cholesteric liquid crystal layer 21 is the same as that of FIG. 3. In addition, the cholesteric liquid crystal layer 21 is the same as the cholesteric liquid crystal layer 18 in that they have the refractive index ellipsoid.

In the following description, the configuration in which the optical axis of the liquid crystal compound is tilted with respect to the main surface of the cholesteric liquid crystal layer also has a pretilt angle.

The cholesteric liquid crystal layer may have a configuration in which the optical axis of the liquid crystal compound has a pretilt angle at one interface among the upper and lower interfaces or may have a pretilt angle at both of the interfaces. In addition, the pretilt angles at both of the interfaces may be different from each other.

In a case where the cholesteric liquid crystal layer has the pretilt angle on the surface, the liquid crystal layer further has a tilt angle due to the influence of the surface even in a bulk portion distant from the surface. The liquid crystal compound has the pretilt angle (is tilted). As a result, in a case where light is diffracted, the effective birefringence index of the liquid crystal compound increases, and the diffraction efficiency can be improved.

The pretilt angle can be measured by cutting the liquid crystal layer with a microtome and observing a cross-section with a polarization microscope.

In the present invention, light that is vertically incident into the cholesteric liquid crystal layer travels obliquely in an oblique direction in the cholesteric liquid crystal layer along with a bending force. In a case where light travels in the cholesteric liquid crystal layer, diffraction loss is generated due to a deviation from conditions such as a diffraction period that are set to obtain a desired diffraction angle with respect to the vertically incident light.

In a case where the liquid crystal compound is tilted, an orientation in which a higher birefringence index is generated than that in an orientation in which light is diffracted as compared to a case where the liquid crystal compound is not tilted is present. In this direction, the effective extraordinary light refractive index increases, and thus the birefringence index as a difference between the extraordinary light refractive index and the ordinary light refractive index increases.

By setting the orientation of the pretilt angle according to the desired diffraction orientation, a deviation from the original diffraction conditions in the orientation can be suppressed. As a result, it is presumed that, in a case where the liquid crystal compound having a pretilt angle is used, a higher diffraction efficiency can be obtained.

The pretilt angle is in a range of 0 degrees to 90 degrees. However, in a case where the pretilt angle is excessively large, the birefringence index on the front decreases. Therefore, the pretilt angle is desirably about 1 degree to 30 degrees. The pretilt angle is more preferably 3 degrees to 20 degrees and still more preferably 5 degrees to 15 degrees.

In addition, it is desirable that the pretilt angle is controlled by treating the interface of the liquid crystal layer. By pretilting the alignment film on the support side interface, the pretilt angle of the liquid crystal compound can be controlled. For example, by exposing the alignment film to ultraviolet light from the front and subsequently obliquely exposing the alignment film during the formation of the alignment film, the liquid crystal compound in the cholesteric liquid crystal layer formed on the alignment film can be made to have a pretilt angle. In this case, the liquid crystal compound is pretilted in a direction in which the single axis side of the liquid crystal compound can be seen with respect to the second irradiation direction. Since the liquid crystal compound having an orientation in a direction perpendicular to the second irradiation direction is not pretilted, a region where the liquid crystal compound is pretilted and a region where the liquid crystal compound is not pretilted are present. This configuration is suitable for improving the diffraction efficiency because it contributes to the most improvement of birefringence in the desired direction in a case where light is diffracted in the direction.

Further, an additive for promoting the pretilt angle can also be added to the cholesteric liquid crystal layer or to the alignment film. In this case, the additive can be used as a factor for further improving the diffraction efficiency.

This additive can also be used for controlling the pretilt angle on the air side interface.

In addition, the cholesteric liquid crystal layer in the optical element according to the embodiment of the present invention may be configured to have regions in which lengths of the single periods in the liquid crystal alignment pattern are different in a plane.

Here, as described above, in the cholesteric liquid crystal layer having the liquid crystal alignment pattern, the reflection angle of light from the equiphase surface E of the cholesteric liquid crystal layer varies depending on the length Λ of the single period of the liquid crystal alignment pattern over which the optical axis 40A rotates by 180°. Specifically, as the length of the single period Λ decreases, the angle of reflected light with respect to incidence light increases. Accordingly, with the configuration in which the cholesteric liquid crystal layer has regions in which lengths of the single periods in the liquid crystal alignment pattern are different in a plane, the optical element can diffract the primary reflected light and the secondary reflected light at different diffraction angles depending on the in-plane regions.

The optical axis 40A of the liquid crystal compound 40 in the liquid crystal alignment pattern of the cholesteric liquid crystal layer shown in FIG. 3 continuously rotates only in the arrow X1 direction.

However, the present invention is not limited thereto, and various configurations can be used as long as the optical axis 40A of the liquid crystal compound 40 in the cholesteric liquid crystal layer continuously rotates in the one in-plane direction.

For example, a cholesteric liquid crystal layer 22 conceptually shown in a plan view of FIG. 14 can be used, in which a liquid crystal alignment pattern is a concentric circular pattern having a concentric circular shape where the one in-plane direction in which the direction of the optical axis of the liquid crystal compound 40 changes while continuously rotating moves from an inside toward an outside.

Alternatively, a liquid crystal alignment pattern can also be used where the one in-plane direction in which the direction of the optical axis of the liquid crystal compound 40 changes while continuously rotating is provided in a radial shape from the center of the cholesteric liquid crystal layer 22 instead of a concentric circular shape.

FIG. 14 shows only the liquid crystal compound 40 of the surface of the alignment film as in FIG. 4. However, as in the example shown in FIG. 4, the patterned cholesteric liquid crystal layer 22 has the helical structure in which the liquid crystal compound 40 on the surface of the alignment film is helically turned and laminated as described above.

This way, in the cholesteric liquid crystal layer 22 having the concentric circular liquid crystal alignment pattern, that is, the liquid crystal alignment pattern in which the optical axis changes while continuously rotating in a radial shape, incidence light can be reflected as diverging light or converging light depending on the rotation direction of the optical axis of the liquid crystal compound 40 and the direction of circularly polarized light to be reflected.

That is, by setting the liquid crystal alignment pattern of the cholesteric liquid crystal layer in a concentric circular shape, the optical element according to the embodiment of the present invention exhibits, for example, a function as a concave mirror or a convex mirror.

Here, in a case where the liquid crystal alignment pattern of the cholesteric liquid crystal layer is concentric circular such that the optical element functions as a concave mirror, it is preferable that the length of the single period Λ over which the optical axis rotates by 180° in the liquid crystal alignment pattern gradually decreases from the center of the cholesteric liquid crystal layer toward the outer direction in the one in-plane direction in which the optical axis continuously rotates.

As described above, the reflection angle of light with respect to an incidence direction increases as the length of the single period Λ in the liquid crystal alignment pattern decreases. Accordingly, the length of the single period Λ in the liquid crystal alignment pattern gradually decreases from the center of the cholesteric liquid crystal layer toward the outer direction in the one in-plane direction in which the optical axis continuously rotates. As a result, light can be further collected, and the performance as a concave mirror can be improved.

In the present invention, in a case where the optical element functions as a convex mirror, it is preferable that the continuous rotation direction of the optical axis in the liquid crystal alignment pattern is in a direction opposite to that of the case of the above-described concave mirror from the center of the cholesteric liquid crystal layer 22.

In addition, by gradually decreasing the length of the single period Λ over which the optical axis rotates by 180° from the center of the cholesteric liquid crystal layer 22 toward the outer direction in the one in-plane direction in which the optical axis continuously rotates, light incident into the cholesteric liquid crystal layer can be further dispersed, and the performance as a convex mirror can be improved.

In the present invention, in a case where the optical element functions as a convex mirror, it is preferable that a direction of circularly polarized light to be reflected (sense of a helical structure) from the cholesteric liquid crystal layer is reversed to be opposite to that in the case of a concave mirror, that is, the helical turning direction of the cholesteric liquid crystal layer is reversed.

In this case, by gradually decreasing the length of the single period Λ over which the optical axis rotates by 180° from the center of the cholesteric liquid crystal layer 22 toward the outer direction in the one in-plane direction in which the optical axis continuously rotates, light reflected from the cholesteric liquid crystal layer can be further dispersed, and the performance as a convex mirror can be improved.

In a state where the helical turning direction of the cholesteric liquid crystal layer is reversed, it is preferable that the continuous rotation direction of the optical axis in the liquid crystal alignment pattern is reversed from the center of the cholesteric liquid crystal layer. As a result, the optical element can be made to function as a concave minor.

In the present invention, depending on the uses of the optical element, conversely, the length of the single period Λ in the concentric circular liquid crystal alignment pattern may gradually increase from the center of the cholesteric liquid crystal layer toward the outer direction in the one in-plane direction in which the optical axis continuously rotates.

Further, depending on the uses of the optical element such as a case where it is desired to provide a light amount distribution in transmitted light, a configuration in which regions having partially different lengths of the single periods Λ in the one in-plane direction in which the optical axis continuously rotates are provided can also be used instead of the configuration in which the length of the single period Λ gradually changes in the one in-plane direction in which the optical axis continuously rotates.

Here, as described above, the cholesteric liquid crystal layer 22 reflects the primary light and the secondary light having different center wavelengths.

For example, in a configuration where the cholesteric liquid crystal layer 22 functions as a concave minor and the single period Λ in the liquid crystal alignment pattern gradually decreases from the center toward the outer direction, in a case where light is incident from the front direction as shown in FIG. 15, the primary reflected light is diffracted at an angle that varies depending on the incident position as indicated by an arrow of a broken line and thus is focused on a point (focal point). The position at this point varies depending on wavelengths based on the above-described expression. In addition, the secondary reflected light is also diffracted at an angle that varies depending on the incident position as indicated by an arrow of a broken line and thus is focused on a focal point.

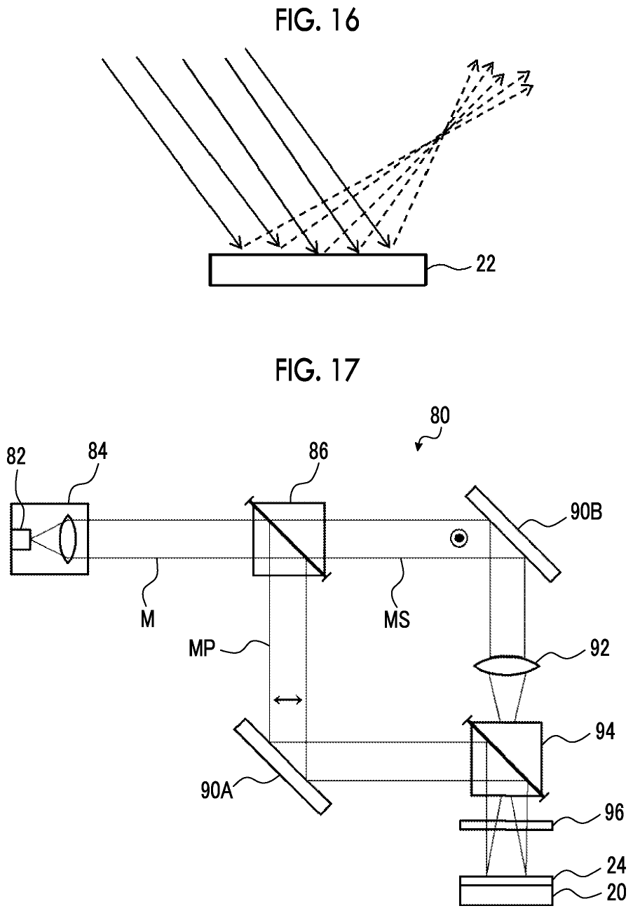

In addition, in a case where light incident into the cholesteric liquid crystal layer 22 from an oblique direction, as shown in FIG. 16, the primary reflected light is reflected in an oblique direction and diffracted at an angle that varies depending on the incident position as indicated by an arrow of a broken line and thus is focused on a point (focal point) in an oblique direction. In addition, the secondary reflected light is also diffracted at an angle that varies depending on the incident position as indicated by an arrow of a broken line and thus is focused on a focal point in an oblique direction.

In the present invention, in a case where the optical element is made to function as a concave mirror or a convex mirror, it is preferable that the optical element satisfies the following Expression.

Φ(r)=(π/λ)[(r²+f²)^{1/2}−f]

Here, r represents a distance from the center of a concentric circle and is represented by Expression “r=(x²+y²)^{1/2}”. x and y represent in-plane positions, and (x,y)=(0,0) represents the center of the concentric circle. Φ(r) represents an angle of the optical axis at the distance r from the center, λ represents the selective reflection center wavelength of the cholesteric liquid crystal layer, and f represents a desired focal length.

FIG. 17 conceptually shows an example of an exposure device that forms the concentric circular alignment pattern in the alignment film.

An exposure device 80 includes: a light source 84 that includes a laser 82; a polarization beam splitter 86 that splits the laser light M emitted from the laser 82 into S polarized light MS and P polarized light MP; a mirror 90A that is disposed on an optical path of the P polarized light MP; a mirror 90B that is disposed on an optical path of the S polarized light MS; a lens 92 that is disposed on the optical path of the S polarized light MS; a polarization beam splitter 94; and a λ/4 plate 96.

The P polarized light MP that is split by the polarization beam splitter 86 is reflected from the mirror 90A to be incident into the polarization beam splitter 94. On the other hand, the S polarized light MS that is split by the polarization beam splitter 86 is reflected from the mirror 90B and is collected by the lens 92 to be incident into the polarization beam splitter 94.

The P polarized light MP and the S polarized light MS are multiplexed by the polarization beam splitter 94, are converted into right circularly polarized light and left circularly polarized light by the λ/4 plate 96 depending on the polarization direction, and are incident into the alignment film 32 on the support 30.

Here, due to interference between the right circularly polarized light and the left circularly polarized light, the polarization state of light with which the alignment film 32 is irradiated periodically changes according to interference fringes. The intersecting angle between the right circularly polarized light and the left circularly polarized light changes from the inside to the outside of the concentric circle. Therefore, an exposure pattern in which the pitch changes from the inside to the outside can be obtained. As a result, in the alignment film 32, a concentric circular alignment pattern in which the alignment state periodically changes can be obtained.

In the exposure device 80, the length Λ of the single period in the liquid crystal alignment pattern in which the optical axis of the liquid crystal compound 40 continuously rotates by 180° can be controlled by changing the refractive power of the lens 92 (the F number of the lens 92), the focal length of the lens 92, the distance between the lens 92 and the alignment film 32, and the like.

In addition, by adjusting the refractive power of the lens 92 (the F number of the lens 92), the length Λ of the single period in the liquid crystal alignment pattern in the one in-plane direction in which the optical axis continuously rotates can be changed. Specifically, in addition, the length Λ of the single period in the liquid crystal alignment pattern in the one in-plane direction in which the optical axis continuously rotates can be changed depending on a light spread angle at which light is spread by the lens 92 due to interference with parallel light. More specifically, in a case where the refractive power of the lens 92 is weak, light is approximated to parallel light. Therefore, the length Λ of the single period in the liquid crystal alignment pattern gradually decreases from the inside toward the outside, and the F number increases. Conversely, in a case where the refractive power of the lens 92 becomes stronger, the length Λ of the single period in the liquid crystal alignment pattern rapidly decreases from the inside toward the outside, and the F number decreases.

This way, the configuration of changing the length of the single period Λ over which the optical axis rotates by 180° in the one in-plane direction in which the optical axis continuously rotates can also be used in the configuration shown in FIGS. 3 and 4 in which the optical axis 40A of the liquid crystal compound 40 changes while continuously rotating only in the one in-plane direction as the arrow X1 direction.

For example, by gradually decreasing the single period Λ of the liquid crystal alignment pattern in the arrow X1 direction, an optical element that reflects light to be collected can be obtained.

In addition, by reversing the direction in which the optical axis in the liquid crystal alignment pattern rotates by 180°, an optical element that reflects light to be diffused only in the arrow X1 direction can be obtained. Likewise, by reversing the direction of circularly polarized light to be reflected (sense of a helical structure) from the cholesteric liquid crystal layer, an optical element that reflects light to be diffused only in the arrow X1 direction can be obtained. By reversing the direction (the sense of the helical structure) in which the optical axis of the liquid crystal alignment pattern rotates by 180° in a state where the direction of circularly polarized light to be reflected from the cholesteric liquid crystal layer, an optical element that reflects light to be collected can be obtained.

Further, depending on the uses of the optical element such as a case where it is desired to provide a light amount distribution in diffracted light, a configuration in which regions having partially different lengths of the single periods Λ in the arrow X1 direction are provided can also be used instead of the configuration in which the length of the single period Λ gradually changes in the arrow X1 direction. For example, as a method of partially changing the single period Λ, for example, a method of scanning and exposing the photo-alignment film to be patterned while freely changing a polarization direction of laser light to be collected can be used.

The optical element according to the embodiment of the present invention may include two or more cholesteric liquid crystal layers.

In a case where the optical element includes two or more cholesteric liquid crystal layers, helical pitches of cholesteric structures of the cholesteric liquid crystal layers can be set to be different from each other such that selective reflection wavelengths are different from each other.

With the configuration in which the optical element includes two or more cholesteric liquid crystal layers having different selective reflection wavelengths, a plurality of secondary reflected light components in a narrow wavelength range having different center wavelengths and narrow half-widths can be obtained.

In a case where a plurality of secondary reflected light components in a narrow wavelength range having narrow half-widths are obtained with the configuration in which the optical element includes two or more cholesteric liquid crystal layers having different selective reflection wavelengths, the diffraction angles of the plurality of secondary reflected light may be the same as or different from each other. For example, in a case where light components in a narrow wavelength range are dispersed and sensed, the diffraction angles may be set to be different from each other. In addition, in a case where the colors of light components in narrow wavelength ranges are uniformly mixed, the diffraction angle may be set to be the same as each other.

In addition, in a case where the optical element includes two or more cholesteric liquid crystal layers, the lengths of the single periods of the liquid crystal alignment patterns of the cholesteric liquid crystal layers may be different from each other.

For example, with the configuration including two or more cholesteric liquid crystal layers in which the selective reflection wavelengths are the same and the lengths of the single periods of the liquid crystal alignment patterns are different from each other, secondary reflected light in a narrow wavelength range having a narrow half-width can be extracted in a plurality of directions (angles).

In addition, in a case where the optical element includes two or more cholesteric liquid crystal layers, the selective reflection wavelengths of the cholesteric liquid crystal layers may be different from each other, and the lengths of the single periods of the liquid crystal alignment patterns may be different from each other.

With this configuration, a plurality of secondary reflected light components having different center wavelengths can be extracted in different directions (angles).

[Wavelength Selective Filter]

As described above, the optical element according to the embodiment of the present invention can selectively reflect, in the incident light, the primary reflected light having a wavelength corresponding to the helical pitch of the cholesteric liquid crystal layer and the secondary reflected light in a narrow wavelength range having a center wavelength that is half of that of the primary reflected light. Therefore, the optical element according to the embodiment of the present invention can be suitably used as a wavelength selective filter that extracts light having a specific wavelength from white light or light having a plurality of wavelengths.

[Sensor]

The sensor according to the embodiment of the present invention includes: the above-described optical element; and a light-receiving element that receives light reflected from the optical element.

By arranging the light-receiving element in a direction in which the secondary reflected light is reflected from the optical element, whether or not light incident into the optical element includes light having a wavelength of the secondary reflected light, the intensity of the secondary reflected light, and the like can be detected.

As this sensor, for example, a sensor that detects only a wavelength of specific laser light (for example, a distance-measuring sensor) can be used.

The light-receiving element is not particularly limited as long as it can detect secondary light reflected from the optical element, and various well-known light-receiving elements can be used.

The sensor according to the embodiment of the present invention can be used for various applications such as a sensor that selects only a wavelength included in required information. For example, the sensor can be used as a wavelength selective element for optical communication used in a communication field described in WO2018/010675A. For example, as in the example shown in FIG. 22, with the configuration including a plurality of optical elements 116 having different selective reflection peak wavelengths, a light guide portion 115, and a plurality of light-receiving elements 114, the sensor can be used as a wavelength selective element that selectively acquires light having a plurality of given wavelengths.

In the sensor according to the embodiment of the present invention, it is preferable to make a wavelength of a light source and a selective reflection peak wavelength of a band pass filter match. Here, the wavelength of the light source may change depending on an external environment such as an environmental temperature. Therefore, it may be desirable that the selective reflection peak wavelength of the band pass filter changes depending on a temperature change. For example, in a case where a semiconductor laser is used as the light source, along with a temperature increase by 40° C., the wavelength of emitted light increases by about 10 nm.

In order to change the selective reflection peak wavelength of the band pass filter depending on a temperature change, it is preferable that the thermal expansion coefficient of the cholesteric liquid crystal layer of the band pass filter increases to expand depending on a temperature change. That is, it is preferable to make a change rate of the wavelength of the light source and a change rate of the reflection wavelength of the cholesteric liquid crystal layer of the band pass filter depending on a temperature change match. In a case where the cholesteric liquid crystal layer of the band pass filter thermally expands in a thickness direction, the selective reflection peak wavelength also changes.

In addition to the method of increasing the thermal expansion coefficient of the cholesteric liquid crystal layer, a material that causes the thermal expansion coefficient of the support of the cholesteric liquid crystal layer to be a negative value, that is, of which the length decreases along with a temperature increase may be used. By using a support formed of the material that causes the thermal expansion coefficient to be a negative value as the support, along with a temperature increase, the support contracts in an in-plane direction such that the thickness of the cholesteric liquid crystal layer changes to increase. Therefore, in a case where the cholesteric liquid crystal layer thermally expands in the thickness direction, the helical pitch P changes, and the selective reflection peak wavelength also changes.

As the material that causes the thermal expansion coefficient to be a negative value, materials derived from various physical origins such as a transverse oscillation mode, a rigid unit mode, or a phase transition, for example, cubic zirconium tungstate, a rubbery elastomer, quartz, zeolite, high-purity silicon, cubic scandium fluoride, high-strength polyethylene fiber, or the like is known, and the materials are also described in detail in Sci. Technol. Adv. Mater. 13 (2012)013001.

In addition, by setting the thermal expansion coefficient in a plane of the support to be appropriate value, the temperature dependence of the angle of the selective wavelength peak can also be controlled. In a case where the thermal expansion coefficient in a plane of the support is positive, along with a temperature increase, the angle decreases. In a case where the thermal expansion coefficient in a plane of the support is positive, along with a temperature increase, the angle increases. In addition, in a case where the thermal expansion coefficient in a plane of the support is zero, there is no temperature dependence. As the material for controlling the thermal expansion coefficient, a generally known material can be used.

In addition, by forcibly applying an external force in an in-plane direction of the cholesteric liquid crystal layer to expand and contract the cholesteric liquid crystal layer, the selective reflection peak wavelength of the band pass filter may change. For example, in a case where the cholesteric liquid crystal layer is interposed with bimetal from both sides, the cholesteric liquid crystal layer can be caused to expand and contract depending on a temperature change to control the temperature dependence of the selective reflection peak wavelength. Any mechanism that imparts another displacement may be provided. As a result, the selective peak wavelength can be controlled to have any temperature dependence depending on various external stimuli. The selective peak wavelength may be adjusted to have the temperature dependence of the wavelength of the light source or may be adjusted such that the temperature dependence is zero.

In the sensor according to the embodiment of the present invention, by imparting a bias to the monotonous periodic structure of the liquid crystal compound having refractive index anisotropy in the cholesteric liquid crystal layer and utilizing the high-order periodic component and small phase control, new diffraction characteristics can be generated. In a cholesteric liquid crystal layer other than the cholesteric liquid crystal layer obtained by alignment of the liquid crystal compound, this mechanism can be realized by arranging an alignment element having refractive index anisotropy with a structural bias. For example, the mechanism can also be realized using a method of three-dimensionally laminating aligned anisotropic polymers, a method of using anisotropic polymerization, or a method using a fine structure having a size less than a wavelength of light, that is, a metamaterial.

Hereinabove, the optical element, the wavelength selective filter, and the sensor according to the embodiment of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

(Support and Saponification Treatment of Support)

As the support, a commercially available triacetyl cellulose film (manufactured by Fujifilm Corporation, Z-TAC) was prepared.

The support was caused to pass through a dielectric heating roll at a temperature of 60° C. such that the support surface temperature was increased to 40° C. Next, an alkali solution shown below was applied to a single surface of the support using a bar coater in an application amount of 14 mL (liter)/m², the support was heated to 110° C., and the support was transported for 10 seconds under a steam far infrared heater (manufactured by Noritake Co., Ltd.).

Next, 3 mL/m² of pure water was applied to a surface of the support to which the alkali solution was applied using the same bar coater. Next, water cleaning using a foundry coater and water draining using an air knife were repeated three times, and then the support was transported and dried in a drying zone at 70° C. for 10 seconds. As a result, the alkali saponification treatment was performed on the surface of the support.

Alkali Solution

| | | |
|---|---|---|
| Potassium hydroxide | 4.70 | parts by mass |
| Water | 15.80 | parts by mass |
| Isopropanol | 63.70 | parts by mass |
| Surfactant | | |
| SF-1: C₁₄H₂₉O(CH₂CH₂O)₂OH | 1.0 | part by mass |
| Propylene glycol | 14.8 | parts by mass |

(Formation of Undercoat Layer)

The following coating liquid for forming an undercoat layer was continuously applied to the surface of the support on which the alkali saponification treatment was performed using a #8 wire bar. The support on which the coating film was formed was dried using warm air at 60° C. for 60 seconds and was dried using warm air at 100° C. for 120 seconds. As a result, an undercoat layer was formed.

Coating Liquid for Forming Undercoat Layer

| | | |
|---|---|---|
| The following modified polyvinyl alcohol | 2.40 | parts by mass |
| Isopropyl alcohol | 1.60 | parts by mass |
| Methanol | 36.00 | parts by mass |
| Water | 60.00 | parts by mass |

Modified Polyvinyl Alcohol

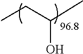

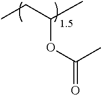

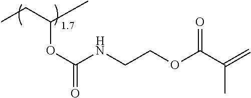

(Formation of Alignment Film)

The following coating liquid for forming an alignment film was continuously applied to the support on which the undercoat layer was formed using a #2 wire bar. The support on which the coating film of the coating liquid for forming an alignment film was formed was dried using a hot plate at 60° C. for 60 seconds. As a result, an alignment film was formed.

Coating Liquid for Forming Alignment Film

| | | |
|---|---|---|
| Material A for photo-alignment | 1.00 | part by mass |
| Water | 16.00 | parts by mass |
| Butoxyethanol | 42.00 | parts by mass |
| Propylene glycol monomethyl ether | 42.00 | parts by mass |

-Material A for Photo-Alignment-

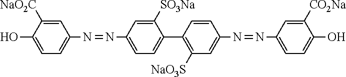

(Exposure of Alignment Film)

The alignment film was exposed using the exposure device shown in FIG. 5 to form an alignment film P-1 having an alignment pattern.

In the exposure device, a laser that emits laser light having a wavelength (325 nm) was used as the laser. The exposure dose of the interference light was 100 mJ/cm². The single period (the length over which the optical axis derived from the liquid crystal compound rotates by 180°) of an alignment pattern formed by interference of two laser beams was controlled by changing an intersecting angle (intersecting angle α) between the two beams.

(Coating Liquid for Forming Cholesteric Liquid Crystal Layer)

The following composition A-1 was prepared, was filtered through a filter formed of polypropylene having a pore diameter of 0.2 μm, and was used as a coating liquid LC-1 for forming a cholesteric liquid crystal layer. LC-1-1 was synthesized using a method described in EP1388538A1, page 21.

Composition A-1

| | | |
|---|---|---|
| Rod-shaped liquid crystal (Paliocolor | 26.7 | parts by mass |
| LC242, manufactured by BASF Japan Ltd) | | |
| Chiral agent (Paliocolor LC756, manu- | 1.2 | parts by mass |
| factured by BASF Japan Ltd) | | |
| Photopolymerization initiator (LC-1-1) | 3.5 | parts by mass |
| Methyl ethyl ketone | 69.3 | parts by mass |

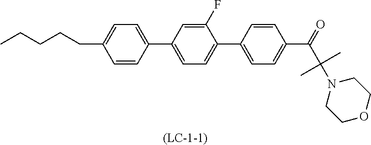 [SMILES: CCCCCc1ccc(-c2ccc(-c3ccc(C(=O)C(C)(C)N4CCOCC4)cc3)c(F)c2)cc1 ; "(LC-1-1)"]

(Polarized UV Irradiation Device POLUV-1)

By using, as an ultraviolet (UV) light source, a microwave-powered ultraviolet irradiation device (Light Hammer 10, 240 W/cm, Fusion UV systems GmbH) on which D-bulb having a strong emission spectrum in 350 to 400 nm was mounted, a wire grid polarization filter (ProFlux PPL 02 (high transmittance type), manufactured by Moxtek, Inc) was provided at a position 10 cm distant from the irradiation surface to prepare the polarized UV irradiation device. The maximum illuminance of the device was 400 mW/cm².

(Formation of Cholesteric Liquid Crystal Layer)

The coating liquid LC-1 for forming a cholesteric liquid crystal layer was applied to the alignment film P-1 using a wire bar coater. After the application, the coating film was heated and dried at a film surface temperature of 100° C. for 1 minute for aging to form a cholesteric liquid crystal layer having a uniform cholesteric liquid crystalline phase.

Further, immediately after aging, the cholesteric liquid crystal layer was irradiated with polarized UV (illuminance: 200 mW/cm², irradiation dose: 600 mJ/cm²) using the polarized UV irradiation device POL-UV-1 in a nitrogen atmosphere where the oxygen concentration was 0.3% or less such that the transmission axis of the polarizing plate was parallel to a direction in which an exposure direction of the alignment film was projected in a plane, that is, an alignment periodic direction. As a result, the cholesteric liquid crystalline phase was immobilized, and a cholesteric liquid crystal layer according to Example 1 was prepared.

The thickness of the prepared cholesteric liquid crystal layer was 5.5 μm.

In a case where the surface of the cholesteric liquid crystal layer was observed with a scanning electron microscope (SEM), the formation of a periodic liquid crystal alignment pattern was verified with a polarization microscope. In the liquid crystal alignment pattern, the single period over which the optical axis derived from the liquid crystal compound rotated by 180° was 1.9 μm.

In a case where the in-plane retardation (nx−ny)×d of the cholesteric liquid crystal layer was measured using M-2000UI (manufactured by J. A. Woollam Co., Ltd.), the in-plane retardation (nx−ny)×d was 47 nm (measurement wavelength: 1000 nm). That is, in the cholesteric liquid crystal layer, a refractive index nx in the slow axis direction and a refractive index ny in the fast axis direction satisfied nx>ny.

### Example 2

A cholesteric liquid crystal layer was prepared using the same method as that of Example 1, except that, during the polarized UV irradiation for the formation of the cholesteric liquid crystal layer, the UV illuminance was 400 mW/cm² and the irradiation dose was 1200 mJ/cm².

The thickness of the prepared cholesteric liquid crystal layer was 5.5 μm.

In a case where the surface of the cholesteric liquid crystal layer was observed with a SEM, the formation of a periodic liquid crystal alignment pattern was verified with a polarization microscope. In the liquid crystal alignment pattern, the single period over which the optical axis derived from the liquid crystal compound rotated by 180° was 1.9 μm.

In a case where the in-plane retardation (nx−ny)×d of the cholesteric liquid crystal layer was measured, the in-plane retardation (nx−ny)×d was 96 nm (measurement wavelength: 1000 nm). That is, in the cholesteric liquid crystal layer, a refractive index nx in the slow axis direction and a refractive index ny in the fast axis direction satisfied nx>ny.

### Example 3

A cholesteric liquid crystal layer was prepared using the same method as that of Example 2, except that, during the polarized UV irradiation for the formation of the cholesteric liquid crystal layer, the polarization direction of UV to be irradiated was adjusted such that the transmission axis of the polarizing plate was perpendicular to the direction in which the exposure direction of the alignment film was projected in a plane, that is, the alignment periodic direction.

The thickness of the prepared cholesteric liquid crystal layer was 5.5 mm.

In a case where the surface of the cholesteric liquid crystal layer was observed with a SEM, the formation of a periodic liquid crystal alignment pattern was verified with a polarization microscope. In the liquid crystal alignment pattern, the single period over which the optical axis derived from the liquid crystal compound rotated by 180° was 1.9 μm.

In a case where the in-plane retardation (nx−ny)×d of the cholesteric liquid crystal layer was measured, the in-plane retardation (nx−ny)×d was 96 nm (measurement wavelength: 1000 nm). That is, in the cholesteric liquid crystal layer, a refractive index nx in the slow axis direction and a refractive index ny in the fast axis direction satisfied nx>ny.

### Comparative Example 1

A cholesteric liquid crystal layer was prepared using the same method as that of Example 1, except that, during the UV irradiation for the formation of the cholesteric liquid crystal layer, the wire grid polarization filter of the polarized UV irradiation device POLUV-1 was detached such that unpolarized UV was irradiated, and the irradiation dose was adjusted using a neutral density (ND) filter for UV irradiation (illuminance: 200 mW/cm², irradiation dose 600 mJ/cm²).

The thickness of the prepared cholesteric liquid crystal layer was 5.5 μm.

In a case where the surface of the cholesteric liquid crystal layer was observed with a SEM, the formation of a periodic liquid crystal alignment pattern was verified with a polarization microscope. In the liquid crystal alignment pattern, the single period over which the optical axis derived from the liquid crystal compound rotated by 180° was 1.9 μm.

In a case where the in-plane retardation (nx−ny)×d of the cholesteric liquid crystal layer was measured, the in-plane retardation (nx−ny)×d was 0 nm (measurement wavelength: 1000 nm). That is, in the cholesteric liquid crystal layer, a refractive index nx in the slow axis direction and a refractive index ny in the fast axis direction did not satisfy nx>ny.

[Evaluation]

The reflection characteristics of each of the prepared cholesteric liquid crystal layers was measured using M-2000 UI (manufactured by J. A. Woollam Co., Ltd.). Incidence light was incident from a direction perpendicular to the surface of the cholesteric liquid crystal layer. The wavelength of the incidence light was 300 nm to 1000 nm. In addition, the diffraction angle varied depending on the wavelength and thus was measured at an angle corresponding to the above-described expression.

In each of the cholesteric liquid crystal layers according to Examples 1 to 3 and Comparative Example 1, reflected light was measured in a direction centering on a polar angle of 25° as an angle deviated from the front surface. The reflected light was primary light.

FIGS. 18 and 20 show graphs obtained by measuring a relationship between a wavelength and a diffraction efficiency. The diffraction angle varied depending on the wavelength and thus was measured at an angle corresponding to the above-described expression. FIG. 18 shows the case of Example 1, and FIG. 20 shows the case of Comparative Example 1. FIGS. 18 and 20 are graphs showing a relationship between a wavelength and a diffraction efficiency of the primary reflected light.

It can be seen from FIG. 18 that, in the case of Example 1, the center wavelength of the primary reflected light was 800 nm and the half-width was 90 nm. It can be seen from FIG. 20 that, in the case of Comparative Example 1, the center wavelength of the primary reflected light was 800 nm and the half-width was 90 nm. Likewise, in Examples 2 and 3, in a case where the center wavelength of the half-width of the primary reflected light were obtained, the center wavelength of the primary reflected light was about 800 nm, and the half-width thereof was 90 nm.

The reflection angle, the center wavelength, and the half-width of the primary reflected light of the cholesteric liquid crystal layer depend on the single period of the liquid crystal alignment pattern and the helical pitch of the cholesteric liquid crystalline phase. In Examples 1 to 3 and Comparative Example 1, the single period of the liquid crystal alignment pattern and the helical pitch of the cholesteric liquid crystalline phase were the same, and thus the reflection angle, the center wavelength, and the half-width of the primary reflected light were the same.

Further, in the cholesteric liquid crystal layers according to Examples 1 to 3, reflected light was measured in a direction at a polar angle of 25° with respect to a direction in which the direction of the optical axis derived from the liquid crystal compound of the liquid crystal alignment pattern rotated. The reflected light was secondary light.

FIGS. 19 and 21 show graphs obtained by measuring a relationship between a wavelength and a diffraction efficiency in a direction at a polar angle of 25°. FIG. 19 shows the case of Example 1, and FIG. 21 shows the case of Comparative Example 1. FIG. 19 is a graph showing a relationship between a wavelength and a diffraction efficiency of the secondary reflected light.

It can be seen from FIG. 19 that, in the case of Example 1, the center wavelength of the secondary reflected light was about 400 nm and the half-width was 25 nm. Likewise, in Examples 2 and 3, in a case where the center wavelength of the half-width of the primary reflected light were obtained, the center wavelength of the secondary reflected light was about 400 nm. The half-width was 16 nm in Example 2 and was 13 nm in Example 3.

On the other hand, as can be seen from FIG. 21, the secondary reflected light was not measured in the case of Comparative Example 1.

The results are shown in Table 1 below.

TABLE 1

| | | | Comparative | | | |
|---|---|---|---|---|---|---|
| | | | Example 1 | Example 1 | Example 2 | Example 3 |
| Preparation | UV Irradiation | Polarized | Unpolarized | Polarized | Polarized | Polarized |
| Conditions of | | Polarization Direction | — | Parallel to | Parallel to | Perpendicular to |
| Cholesteric | | | | Periodic | Periodic | Periodic |
| Liquid Crystal | | | | Direction of | Direction of | Direction of |
| Layer | | | | Alignment | Alignment | Alignment |
| | | | | Pattern | Pattern | Pattern |
| | | UV Illuminance (mW/cm²) | 200 | 200 | 400 | 400 |
| | | UV Irradiation dose (mJ/cm²) | 600 | 600 | 1200 | 1200 |
| Configuration of | | In-Plane Retardation (nm) | 0 | 47 | 96 | 96 |
| Cholesteric | | nx > ny | Not Satisfied | Satisfied | Satisfied | Satisfied |
| Liquid Crystal | | | | | | |
| Layer | | | | | | |
| Evaluation | Primary | Presence | Present | Present | Present | Present |
| | Reflected | Center Wavelength (nm) | 800 | 800 | 800 | 800 |
| | Light | Half-Width (nm) | 90 | 90 | 90 | 90 |
| | | Angle of Center Wavelength | 25 | 25 | 25 | 25 |
| | | (°) | | | | |
| | Secondary | Presence | Not Present | Present | Present | Present |
| | Reflected | Angle (°) | — | 25 | 25 | 25 |
| | Light | Center Wavelength (nm) | — | 400 | 400 | 400 |
| | | Half-Width (nm) | — | 25 | 16 | 13 |
| | | Angle of Center Wavelength | — | 25 | 25 | 25 |
| | | (°) | | | | |

### Example 4

A cholesteric liquid crystal layer was prepared using the same method as that of Example 3, except that preparation conditions of the cholesteric liquid crystal layer were changed as follows from those of Example 3.

(Coating Liquid for Forming Cholesteric Liquid Crystal Elastomer)

As the liquid crystal composition, the following composition A-3 was prepared. This composition A-3 is a liquid crystal composition forming an elastomer of a cholesteric liquid crystal layer (cholesteric liquid crystalline phase) that has a selective reflection center wavelength of 1280 nm and reflects left circularly polarized light.

Composition A-3

| | | |
|---|---|---|
| Rod-shaped liquid crystal compound L-3 | 100.00 | parts by mass |
| Polymerization initiator LC-1-1 | 4.00 | parts by mass |
| Chiral agent Ch-2 | 3.50 | parts by mass |
| Leveling agent T-1 | 0.08 | parts by mass |
| Crosslinking agent (VISCOAT #230, | 6.5 | parts by mass |
| manufactured by Osaka Organic | | |
| Chemical Industry Ltd.) | | |
| Liquid crystal solvent (5CB, manu- | 50.00 | parts by mass |
| factured by Tokyo Chemical | | |
| Industry Co., Ltd.) | | |
| Methyl ethyl ketone | 171.12 | parts by mass |

Rod-shaped liquid crystal compound L-3 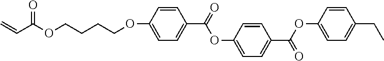 [SMILES: C=CC(=O)OCCCCOc1ccc(C(=O)Oc2ccc(C(=O)Oc3ccc(CC)cc3)cc2)cc1]
Chiral agent Ch-2

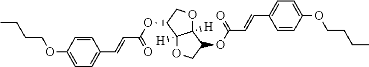

(Formation of Cholesteric Liquid Crystal Elastomer)

The above-described composition A-3 was applied to the alignment film P-1. The applied coating film was heated to 95° C. using a hot plate, was cooled to 80° C., and was irradiated (illuminance: 200 mW/cm² and irradiation dose: 600 mJ/cm²) with polarized UV using the polarized UV irradiation device in a nitrogen atmosphere. As a result, the cholesteric liquid crystalline phase was immobilized to form a liquid crystal gel.

After peeling the liquid crystal gel from the alignment film P-1, the liquid crystal gel was dipped in methyl ethyl ketone in a stainless steel tray and was cleaned to remove the liquid crystal solvent. After cleaning, the liquid crystal gel was dried in an oven at 100° C. for 15 minutes to form a liquid crystal elastomer in which the cholesteric liquid crystalline phase was immobilized.

The prepared cholesteric liquid crystal layer was evaluated using the same method as that of Example 3. As a result, the primary reflected light and the secondary reflected light were measured as in Example 3. As a result, it can be seen that, even in a case where the liquid crystal elastomer is used, the same effects can be obtained.

As described above, in Examples 1 to 4 as the cholesteric liquid crystal layer according to the embodiment of the present invention, the secondary reflected light in a narrow wavelength range having a narrower half-width than the primary reflected light can be obtained.

As can be seen from the above results, the effects of the present invention are obvious.

### EXPLANATION OF REFERENCES

10, 116: optical element
18, 21, 22: cholesteric liquid crystal layer
30: support
32: alignment film
40: liquid crystal compound
40A: optical axis
60, 80: exposure device
62, 82: laser
64, 84: light source
65: λ/2 plate
68, 88, 94: polarization beam splitter
70A, 70B, 90A, 90B: mirror
72A, 72B, 96: λ/4 plate
92: lens
100: cholesteric liquid crystal layer in the related art
102: liquid crystal compound
114: light-receiving element
115: light guide portion
R_{R}: right circularly polarized light of red light
M: laser light
MA, MB: beam
MP: P polarized light
MS: S polarized light
P_{O}: linearly polarized light
P_{R}: right circularly polarized light
P_{L}: left circularly polarized light
Q: absolute phase
E: equiphase surface
L₁, L₂, L₃, L₄, L₅: light
Λ: single period
X1, A₁, A₂, A₃: one in-plane direction
C1 to C7: liquid crystal compound
θ₁ to θ₆: angle

What is claimed is:

1. An optical element comprising:
a cholesteric liquid crystal layer obtained by cholesteric alignment of a liquid crystal compound,
wherein the cholesteric liquid crystal layer has a liquid crystal alignment pattern in which a direction of an optical axis derived from the liquid crystal compound changes while continuously rotating in at least one in-plane direction, and
the cholesteric liquid crystal layer has a region where a refractive index nx in an in-plane slow axis direction and a refractive index ny in an in-plane fast axis direction satisfy nx>ny.

2. The optical element according to claim 1,
wherein in a case where a thickness of the cholesteric liquid crystal layer is represented by d, (nx−ny)×d is 47 nm or more.

3. The optical element according to claim 1,
wherein the liquid crystal alignment pattern of the cholesteric liquid crystal layer is a concentric circular pattern having a concentric circular shape where the one in-plane direction in which the direction of the optical axis derived from the liquid crystal compound changes while continuously rotating moves from an inside toward an outside.

4. The optical element according to claim 1,
wherein in a case where a length over which the direction of the optical axis derived from the liquid crystal compound in the liquid crystal alignment pattern rotates by 180° in a plane is set as a single period, the cholesteric liquid crystal layer has regions in which different lengths of the single periods in the liquid crystal alignment pattern are different in a plane.

5. The optical element according to claim 1, comprising:
two or more of the cholesteric liquid crystal layers,
wherein helical pitches of cholesteric structures of the cholesteric liquid crystal layers are different from each other.

6. The optical element according to claim 1, comprising:
two or more of the cholesteric liquid crystal layers,
wherein in a case where a length over which the direction of the optical axis derived from the liquid crystal compound in the liquid crystal alignment pattern rotates by 180° in a plane is set as a single period, the lengths of the single periods in the liquid crystal alignment patterns of the cholesteric liquid crystal layers are different from each other.

7. The optical element according to claim 1,
wherein the cholesteric liquid crystal layer is formed of a liquid crystal elastomer.

8. A wavelength selective filter comprising:
the optical element according to claim 1.

9. A sensor comprising:
the optical element according to claim 1; and
a light-receiving element that receives light reflected from the optical element.

10. The optical element according to claim 2,
wherein the liquid crystal alignment pattern of the cholesteric liquid crystal layer is a concentric circular pattern having a concentric circular shape where the one in-plane direction in which the direction of the optical axis derived from the liquid crystal compound changes while continuously rotating moves from an inside toward an outside.

11. The optical element according to claim 2,
wherein in a case where a length over which the direction of the optical axis derived from the liquid crystal compound in the liquid crystal alignment pattern rotates by 180° in a plane is set as a single period, the cholesteric liquid crystal layer has regions in which different lengths of the single periods in the liquid crystal alignment pattern are different in a plane.

12. The optical element according to claim 2, comprising:
two or more of the cholesteric liquid crystal layers,
wherein helical pitches of cholesteric structures of the cholesteric liquid crystal layers are different from each other.

13. The optical element according to claim 2, comprising:
two or more of the cholesteric liquid crystal layers,
wherein in a case where a length over which the direction of the optical axis derived from the liquid crystal compound in the liquid crystal alignment pattern rotates by 180° in a plane is set as a single period, the lengths of the single periods in the liquid crystal alignment patterns of the cholesteric liquid crystal layers are different from each other.

14. The optical element according to claim 2,
wherein the cholesteric liquid crystal layer is formed of a liquid crystal elastomer.

15. A wavelength selective filter comprising:
the optical element according to claim 2.

16. A sensor comprising:
the optical element according to claim 2; and
a light-receiving element that receives light reflected from the optical element.

17. The optical element according to claim 3,
wherein in a case where a length over which the direction of the optical axis derived from the liquid crystal compound in the liquid crystal alignment pattern rotates by 180° in a plane is set as a single period, the cholesteric liquid crystal layer has regions in which different lengths of the single periods in the liquid crystal alignment pattern are different in a plane.

18. The optical element according to claim 3, comprising:
two or more of the cholesteric liquid crystal layers,
wherein helical pitches of cholesteric structures of the cholesteric liquid crystal layers are different from each other.

19. The optical element according to claim 3, comprising:
two or more of the cholesteric liquid crystal layers,
wherein in a case where a length over which the direction of the optical axis derived from the liquid crystal compound in the liquid crystal alignment pattern rotates by 180° in a plane is set as a single period, the lengths of the single periods in the liquid crystal alignment patterns of the cholesteric liquid crystal layers are different from each other.

20. The optical element according to claim 3,
wherein the cholesteric liquid crystal layer is formed of a liquid crystal elastomer.
